(19) United States
(12) Patent Application Publication
(10) Pub. No.: US 2005/0086306 A1
(43) Pub. Date: Apr. 21, 2005

(54) Providing background delivery of messages over a network

(76) Inventor: Ralph E. Lemke, Sunnyvale, CA (US)

Correspondence Address: BURT MAGEN ESQ;VIERRA MAGEN MARCUS HARMON & DENIRO LLP, 685 MARKET STREET, SUITE 540, SAN FRANCISCO, CA, 94105, US

(21) Appl. No.: 10/390,569

(22) Filed: Mar. 14, 2003

(51) Int. Cl. G06F 15/16

(52) U.S. Cl. 709/206; 709/228

(57) ABSTRACT

The present invention is directed to technology for managing the transfer of messages, such as e-mails, over a network. Messages can be transferred over the network through background delivery. A proxy server resides between an e-mail client and an e-mail server to receive outbound electronic messages sent by the e-mail client. The proxy server determines whether the outgoing electronic message should be scheduled for background delivery. If not, the proxy server forwards the electronic message to the e-mail server for traditional delivery. Otherwise, the proxy server prepares content associated with the electronic message for background delivery—creating and packaging one or more assets from the electronic message content. An example of such content is files attached to the electronic message. The e-mail proxy server notifies the intended e-mail recipient that the content is ready to be retrieved. The intended recipient issues a scheduling request calling for delivery of the content. A forward proxy receives and services the scheduling request by arranging for the content to be delivered in accordance with a specified bandwidth schedule.

### CROSS-REFERENCE TO RELATED APPLICATIONS

This Application is related to the following Applications:
U.S. patent application Ser. No. 09/853,816, entitled “System and Method for Controlling Data Transfer Rates on a Network,” filed May 11, 2001;
U.S. patent application Ser. No. 09/935,016, entitled “System and Method for Scheduling and Executing Data Transfers Over a Network,” filed Aug. 21, 2001;
U.S. patent application Ser. No. 09/852,464, entitled “System and Method for Automated and Optimized File Transfers Among Devices in a Network,” filed May 9, 2001;
U.S. patent application Ser. No. 10/356,709, entitled “Scheduling Data Transfers For Multiple Use Request,” Attorney Docket No. RADI-01000US0, filed Jan. 31, 2003; and
U.S. patent application Ser. No. 10/356,714, entitled “Scheduling Data Transfers Using Virtual Nodes,” Attorney Docket No. RADI-01001US0, filed Jan. 31, 2003.

Each of these related Applications is incorporated herein by reference.

### BACKGROUND OF THE INVENTION

1. Field of the Invention

The present invention is directed to technology for transferring messages, such as e-mails, over a network.

2. Description of the Related Art

Traditional systems for delivering messages over a communications network have several drawbacks when the messages are large. For example, large e-mails can cause traditional e-mail delivery systems to create network congestion that ties up costly bandwidth resources. An e-mail with large attachments is delivered in its entirety to all listed recipients, even though some recipients may not need the attachments introducing undesirable redundancy that wastes network bandwidth and data storage resources.

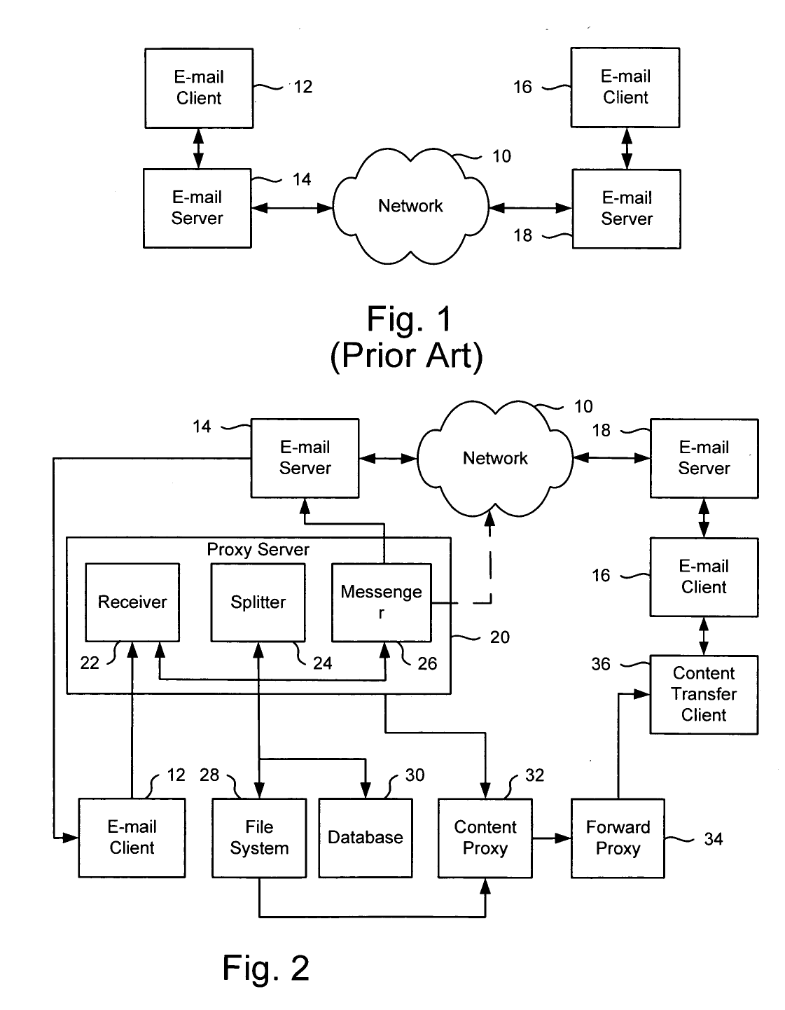

FIG. 1 shows a traditional system for delivering electronic messages, such as e-mail, over network 10. Network 10 facilitates communication between e-mail server 14 and e-mail server 18. Network 10 can be a private local area network, a public network, such as the Internet, or any other type of network that provides for the transfer of data and/or other information. Network 10 can support more or less nodes than shown in FIG. 1.

E-mail servers 14 and 18 receive and transmit e-mails over network 10. In one example, e-mail servers 14 and 18 support Simple Mail Transfer Protocol (SMTP). Servers 14 and 18 support different protocols in other instances. E-mail clients 12 and 16 provide user interfaces that allow users to compose, review, and manage e-mails. In operation, a user employs client 12 to compose an e-mail message with attachments addressed to client 16. Using client 12, the user issues a send command that sends the e-mail to server 14, which sends the e-mail over network 10 to server 18. Server 18 recognizes that the e-mail is addressed to client 16 and delivers it accordingly.

Server 14 sends the e-mail over network 10 as soon as bandwidth is available, regardless of whether the e-mail needs to be delivered immediately. This can lead to a waste of valuable bandwidth, if the e-mail recipient does not need the message until much later. The magnitude of this inefficiency is exacerbated as the size of the e-mail increases. Many e-mail system administrators do not even permit the transmission or reception of excessively large messages.

In one example, a product manager at a corporation needs to send a large volume of sales support materials to all members of a field sales forces. The materials consume 200 megabytes of electronic storage space. Many e-mail systems will not permit the transmission or reception of a 200 megabyte file, and e-mail accounts for the sales force members may not have sufficient resources for storing an e-mail of this size. This forces the product manager to make and mail a CD-ROM version of the materials for each sales force member. It would be significantly more desirable for the product manager to have the ability to send the large volume of materials via e-mail or some other form of electronic message delivery.

### SUMMARY OF THE INVENTION

The present invention, roughly described, pertains to technology for managing the transfer of messages, such as e-mails, over a network. The messages can be transferred over the network through background delivery, which allows message transfers to be scheduled outside the flow of traditional e-mail transmissions. In many instances, this provides improved network bandwidth utilization and allows larger messages transfers.

In one embodiment, a proxy server resides between an e-mail client and an e-mail server to receive outbound e-mail messages sent by the e-mail client. The proxy server determines whether the outgoing e-mail should be scheduled for background delivery. In one embodiment, the proxy server makes this determination based on the size of the e-mail, including attachments. If the e-mail exceeds a predetermined size, the proxy server arranges for content from the e-mail to be delivered to the intended recipient through a scheduled background delivery. Otherwise, the proxy server forwards the e-mail to the e-mail server for traditional delivery.

The proxy server prepares e-mail content, such as attachments, for background delivery. The e-mail proxy server creates and packages one or more assets from the content. The e-mail proxy server sends the intended e-mail recipient a notice when the content is ready to be retrieved. The intended recipient causes a scheduling request to be issued for delivery of the content, and the request is serviced.

In one implementation, one or more forward proxies receive and service scheduling requests by arranging for content to be delivered in accordance with a specified bandwidth schedule. The forward proxy delivers the content at the latest time possible that conforms to the schedule. This enables the content delivery to be made at

FIG. 7B is a flowchart describing one embodiment of a process for issuing a scheduling request for content.

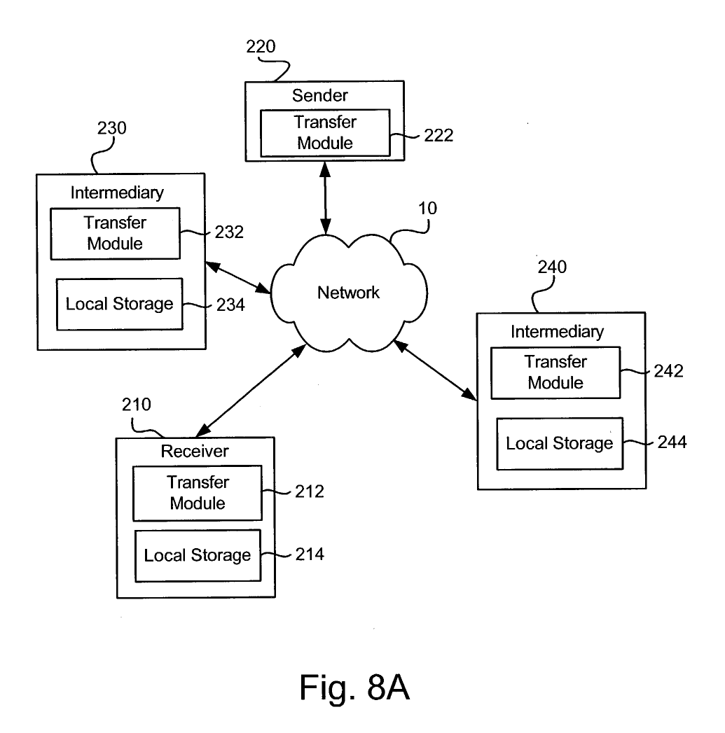

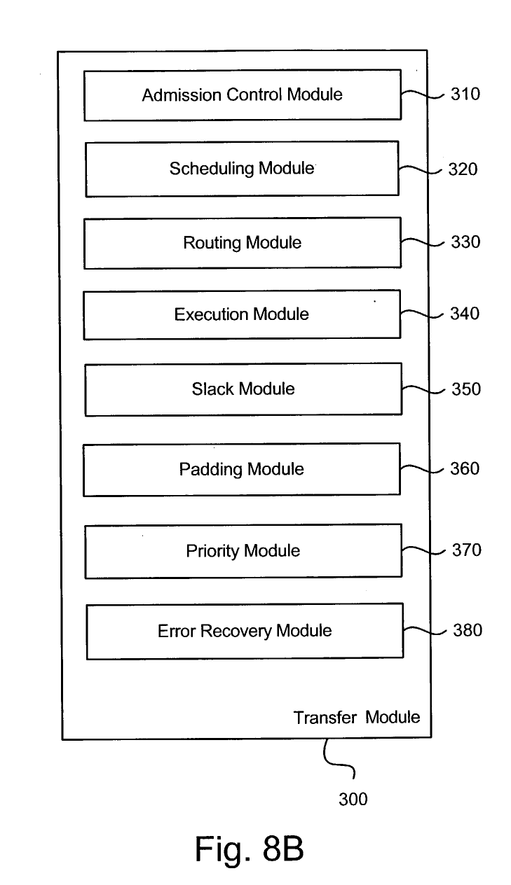

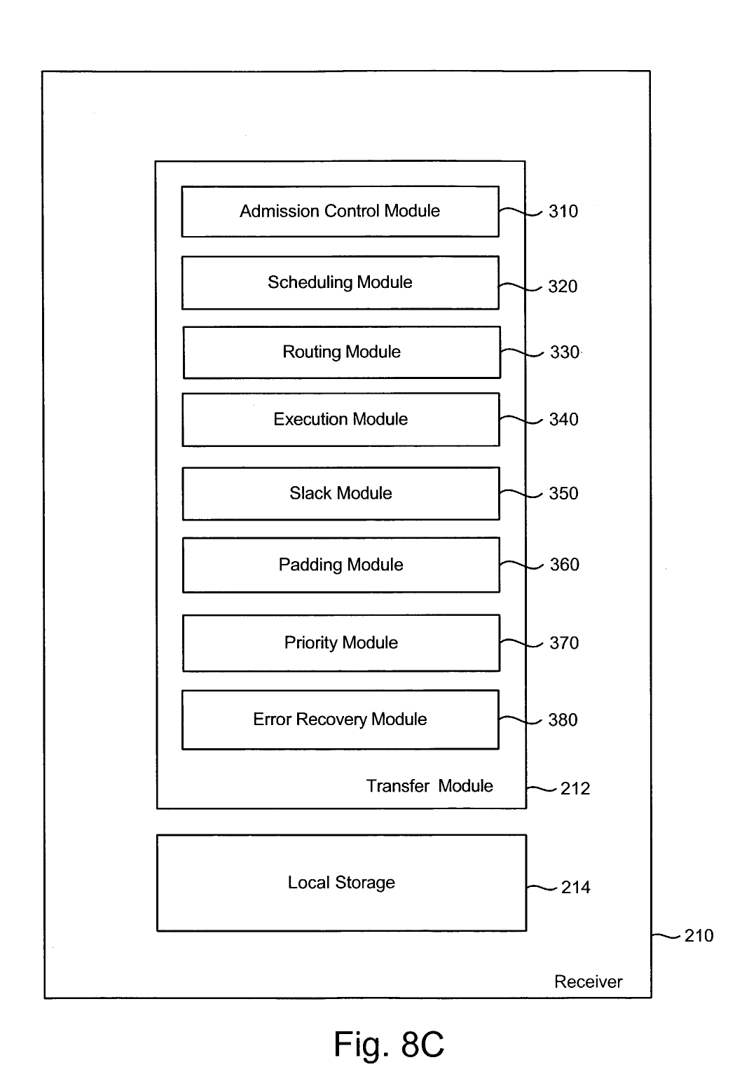

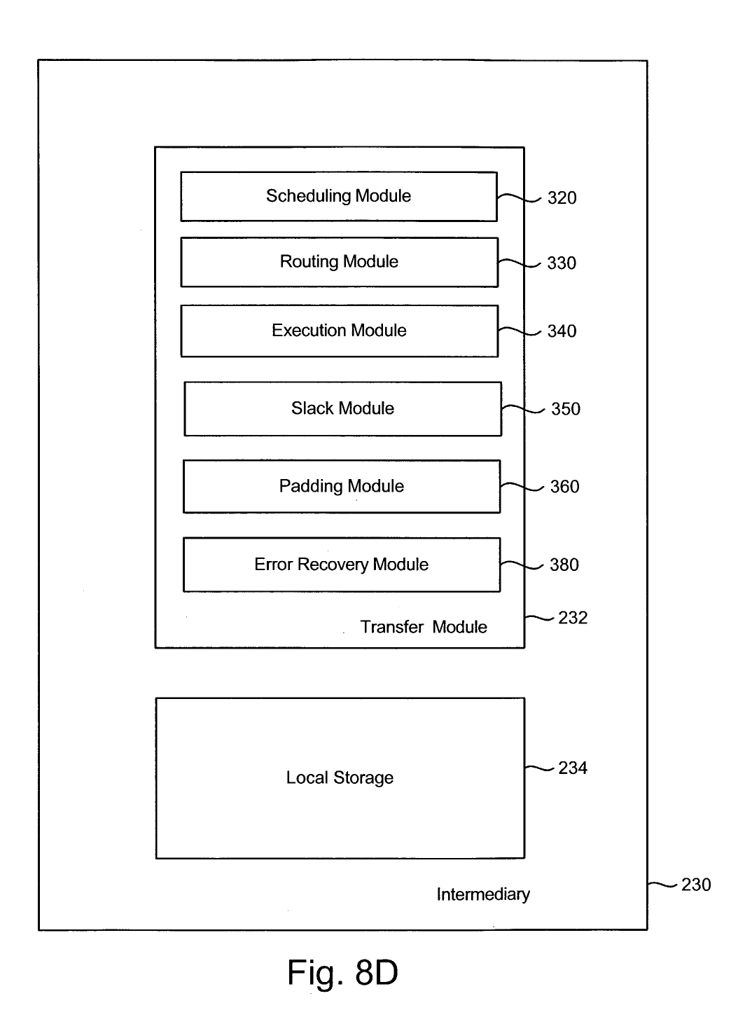

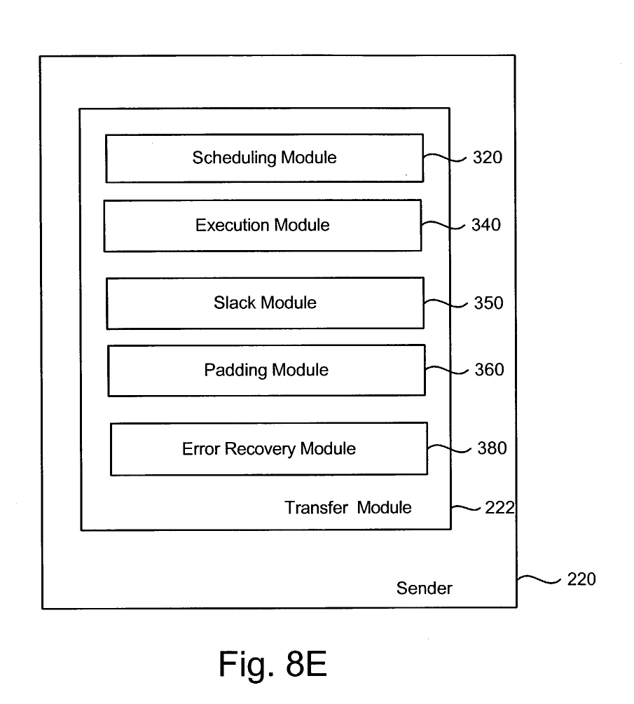

FIG. 8A is a block diagram of network nodes operating as senders, intermediaries, and receivers in one implementation of the present invention.

FIGS. 8B-8E are block diagrams of different transfer module configurations employed in embodiments of the present invention.

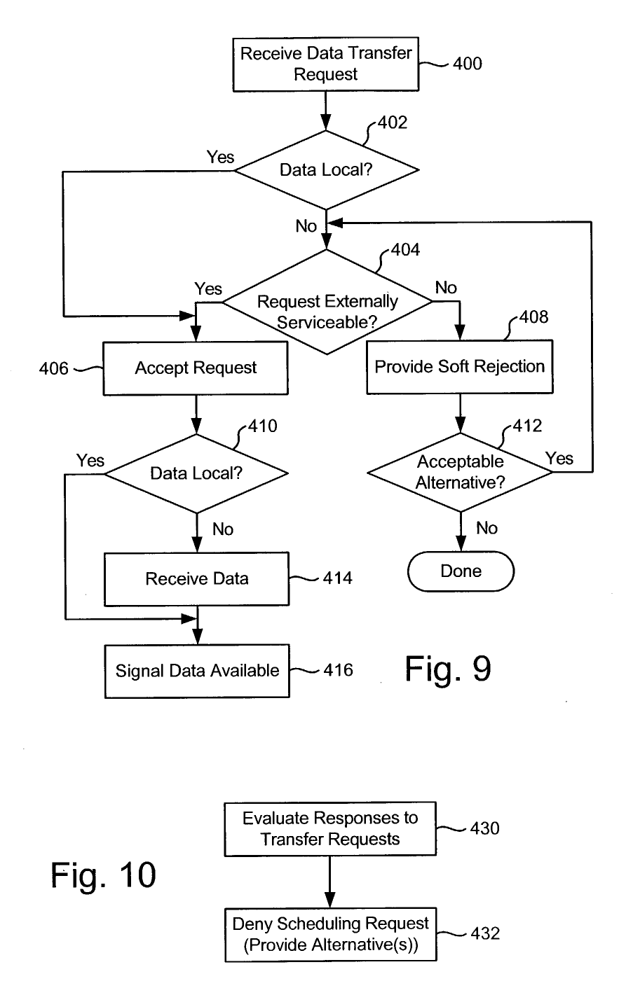

FIG. 9 is a flowchart describing one embodiment of a process for servicing a data transfer request.

FIG. 10 is a flowchart describing one embodiment of a process for providing a soft rejection.

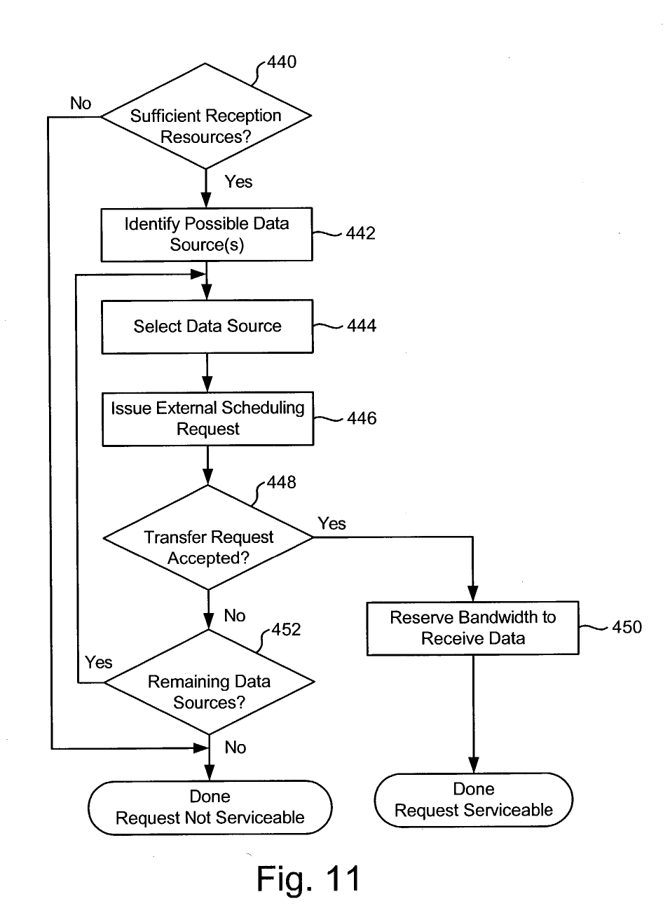

FIG. 11 is a flowchart describing one embodiment of a process for determining whether a data transfer request is serviceable.

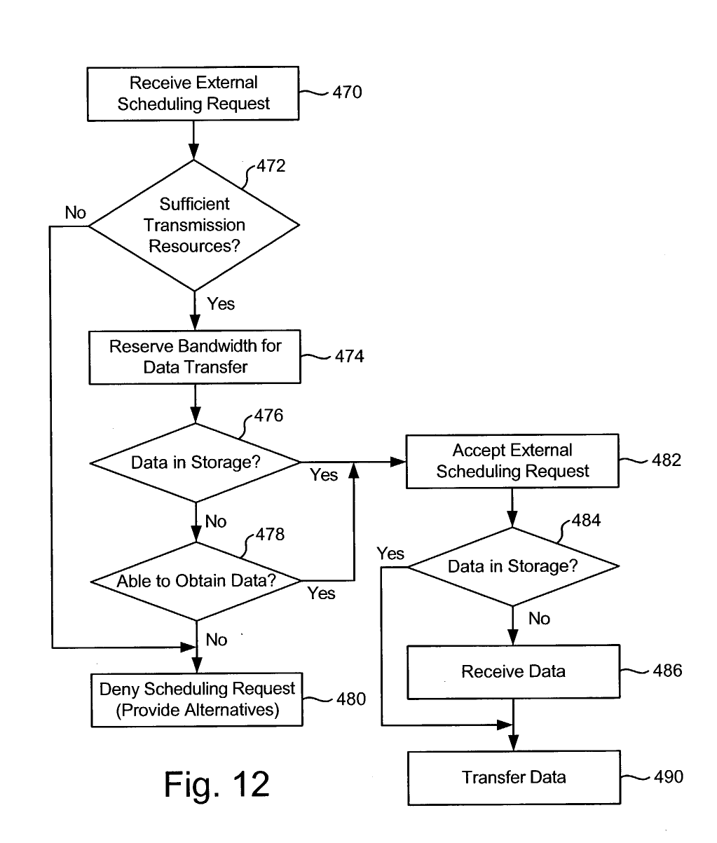

FIG. 12 is a flowchart describing one embodiment of a process for servicing a scheduling request.

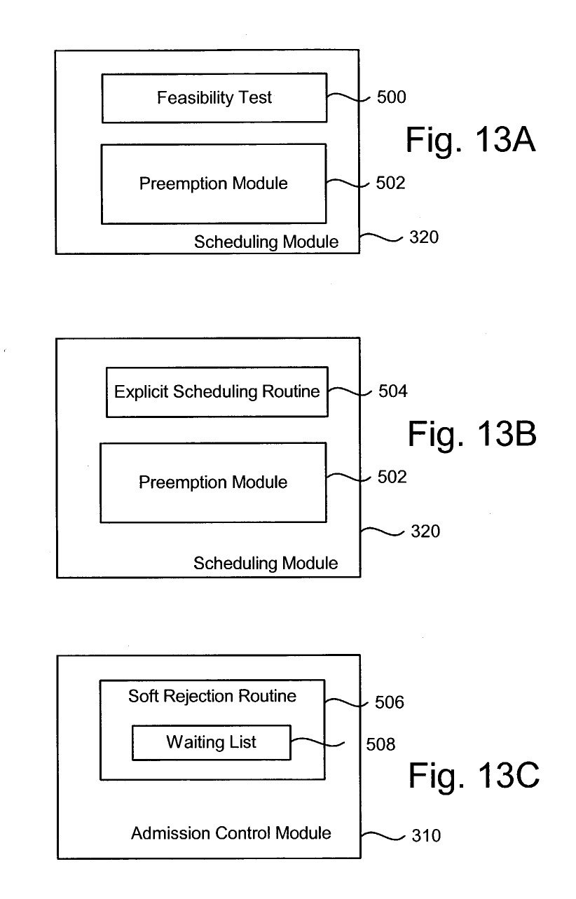

FIG. 13A is a block diagram of a scheduling module in one implementation of the present invention.

FIG. 13B is a block diagram of a scheduling module in an alternate implementation of the present invention.

FIG. 13C is a block diagram of an admission control module in one implementation of the present invention.

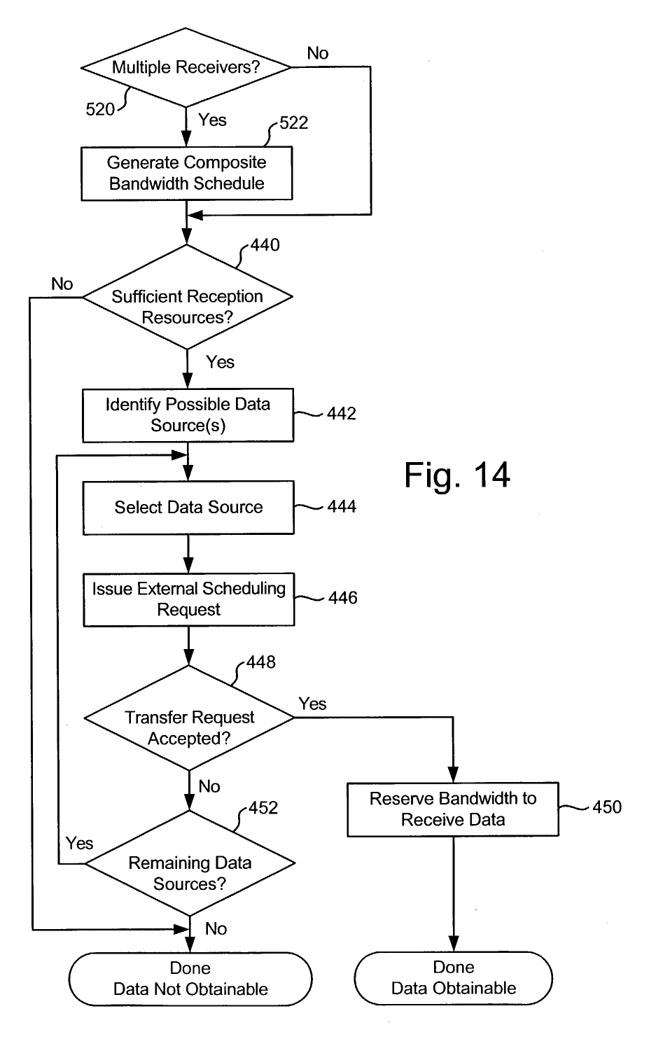

FIG. 14 is a flowchart describing one embodiment of a process for determining whether sufficient transmission resources exist.

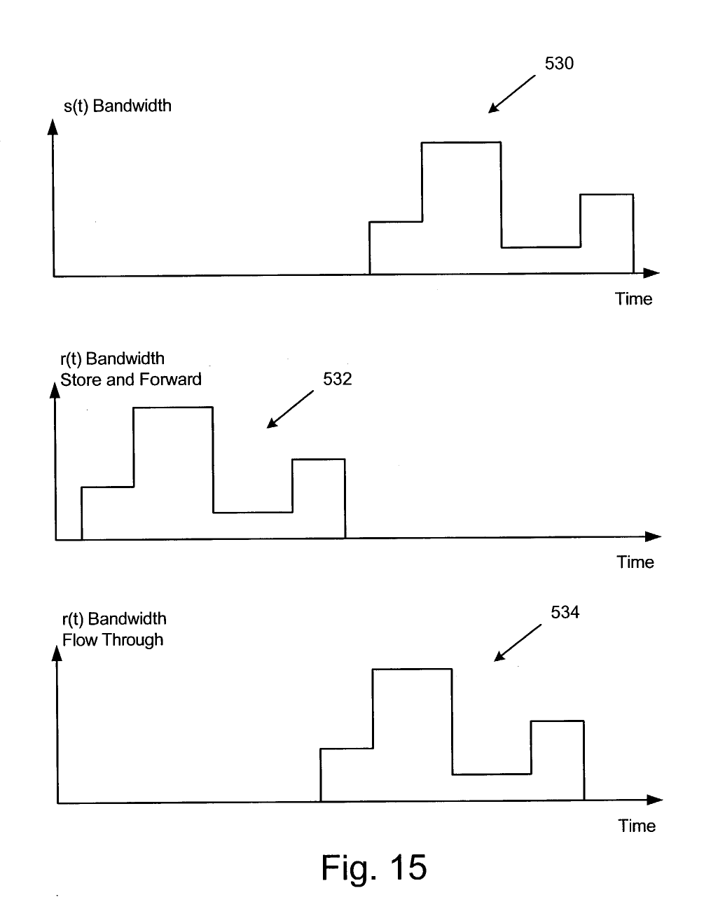

FIG. 15 is a set of bandwidth graphs illustrating the difference between flow through scheduling and store-and-forward scheduling.

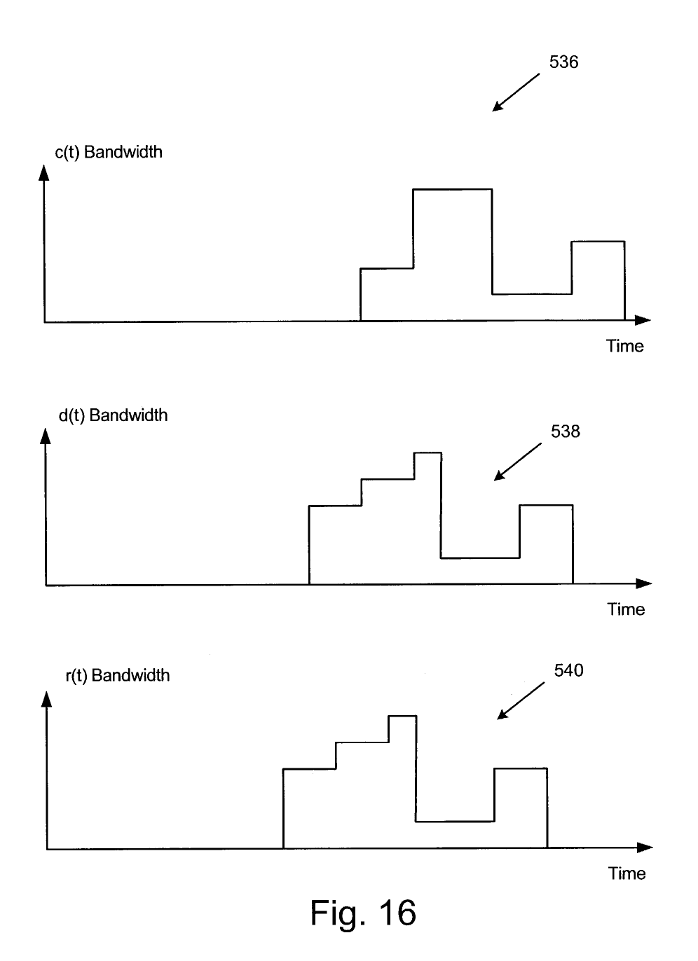

FIG. 16 is a set of bandwidth graphs illustrating one example of flow through scheduling for multiple end nodes in accordance with one embodiment of the present invention.

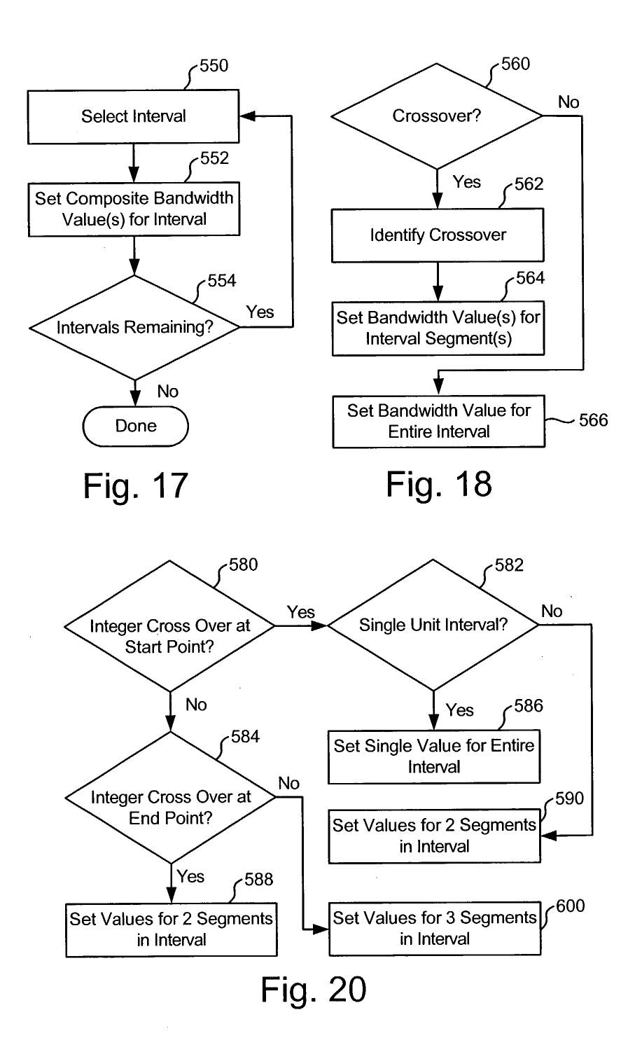

FIG. 17 is a flowchart describing one embodiment of a process for generating a composite bandwidth schedule.

FIG. 18 is a flowchart describing one embodiment of a process for setting composite bandwidth values.

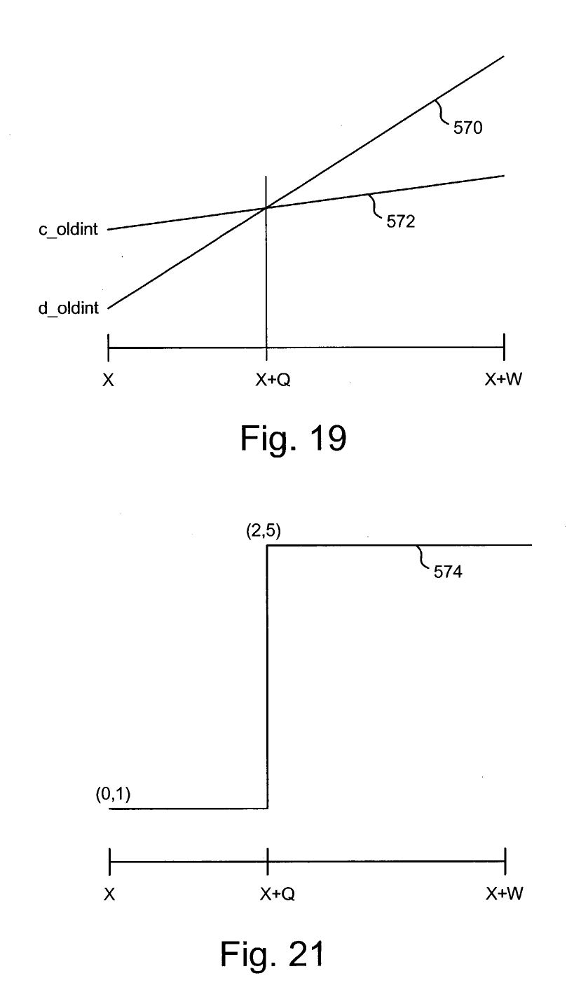

FIG. 19 is a graph showing one example of an interval on data demand curves for a pair of nodes.

FIG. 20 is a flowchart describing one embodiment of a process for setting bandwidth values within an interval.

FIG. 21 is a graph showing a bandwidth curve that meets the data demand requirements for the interval shown in FIG. 19.

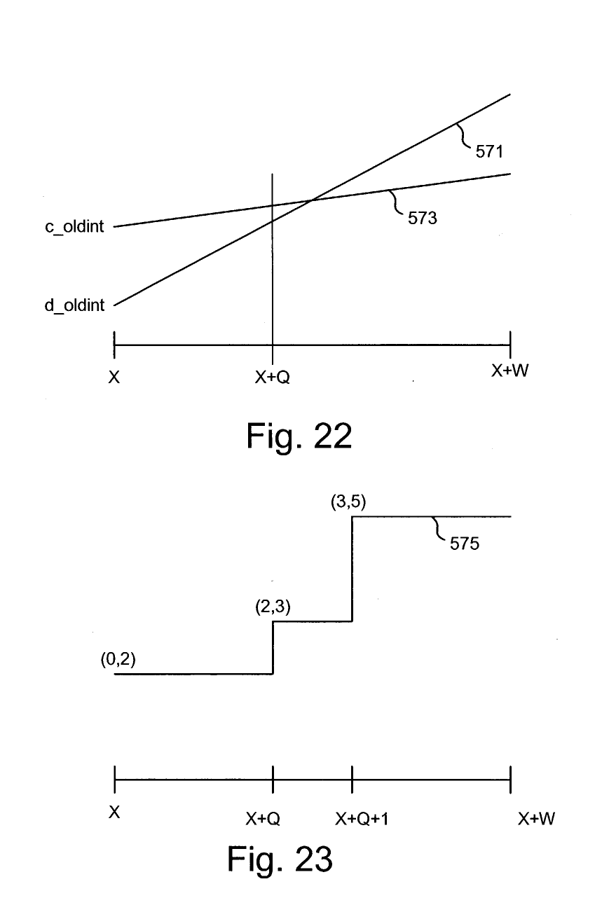

FIG. 22 is a graph showing another example of an interval of data demand curves for a pair of nodes.

FIG. 23 is a graph showing a bandwidth curve that meets the data demand requirements for the interval shown in FIG. 22.

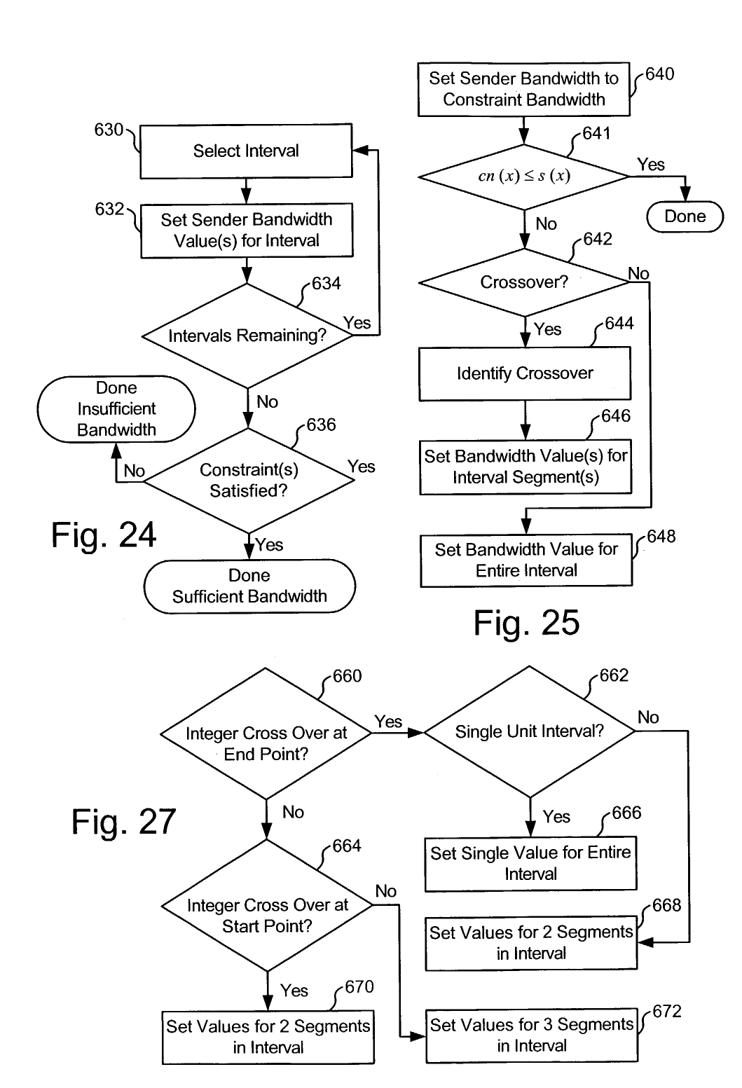

FIG. 24 is a flowchart describing one embodiment of a process for determining whether sufficient transmission bandwidth exists.

FIG. 25 is a flowchart describing one embodiment of a process for generating a send bandwidth schedule.

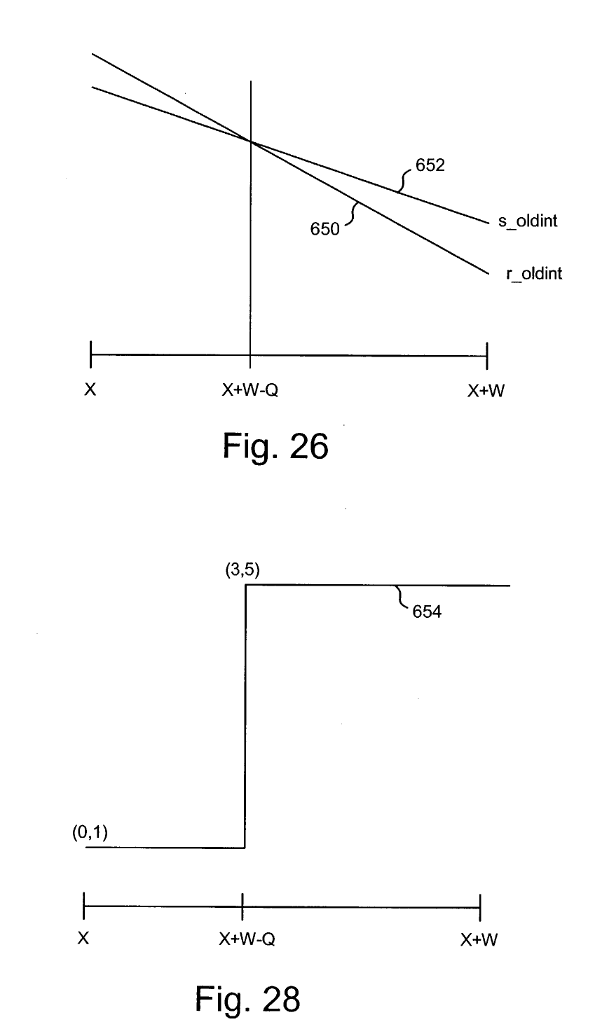

FIG. 26 is a graph showing one example of a selected interval of constraint and scheduling request bandwidth schedules.

FIG. 27 is a flowchart describing one embodiment of a process for setting send bandwidth values within an interval.

FIG. 28 is a graph showing a send bandwidth schedule based on the scenario shown in FIG. 26.

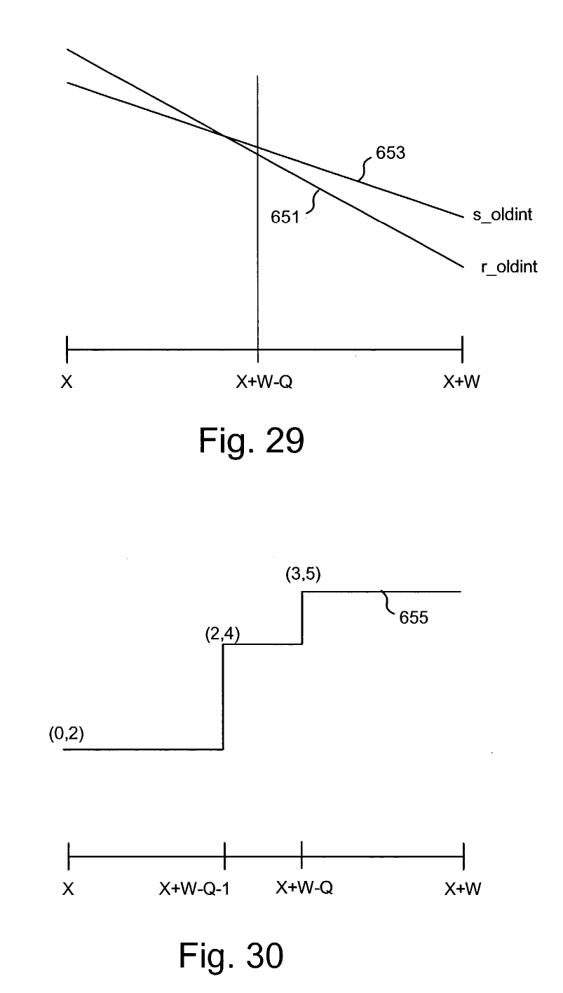

FIG. 29 is a graph showing another example of a selected interval of constraint and scheduling request bandwidth schedules.

FIG. 30 is a graph showing a send bandwidth schedule based on the scenario shown in FIG. 29.

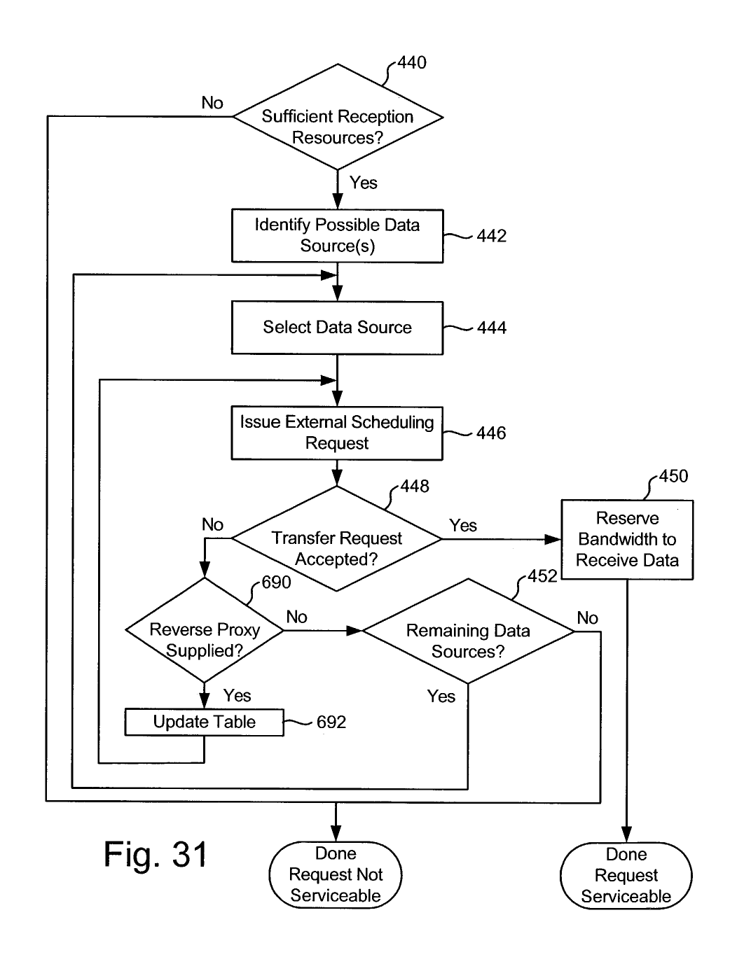

FIG. 31 is a flowchart describing an alternate embodiment of a process for determining whether a data transfer request is serviceable, using proxies.

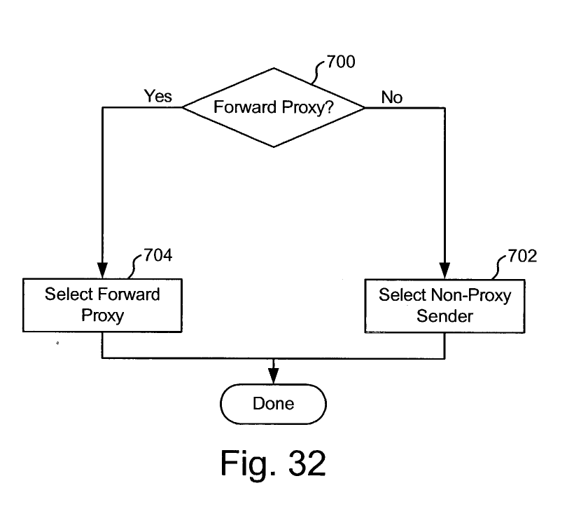

FIG. 32 is a flowchart describing one embodiment of a process for selecting data sources, using proxies.

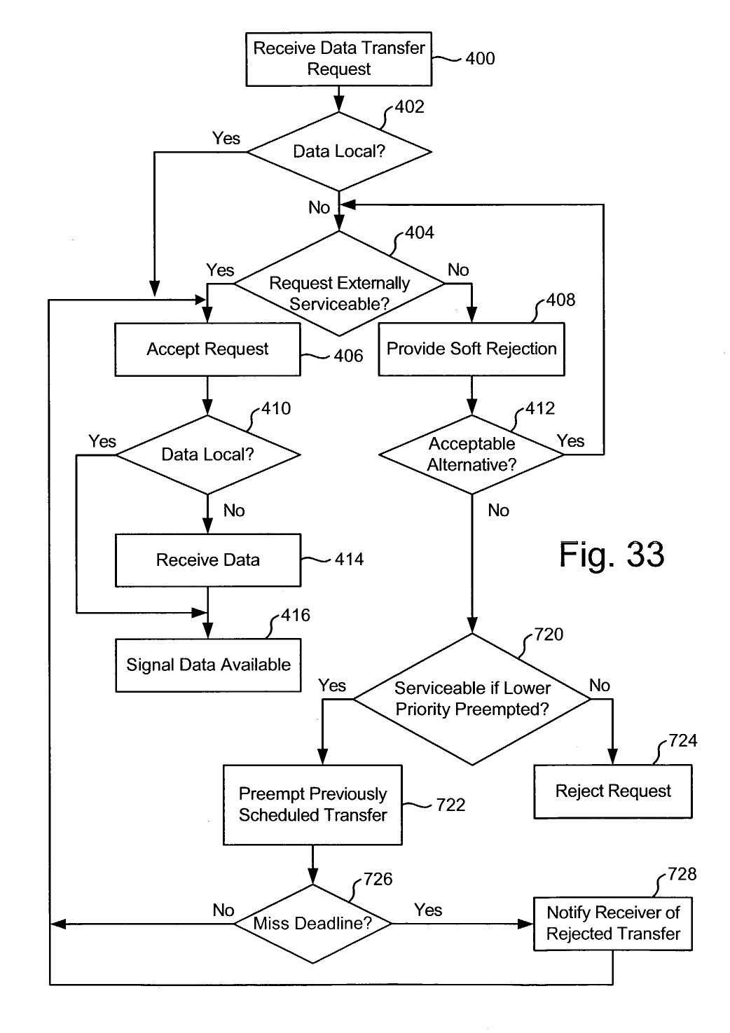

FIG. 33 is a flowchart describing an alternate embodiment of a process for servicing data transfer requests when preemption is allowed.

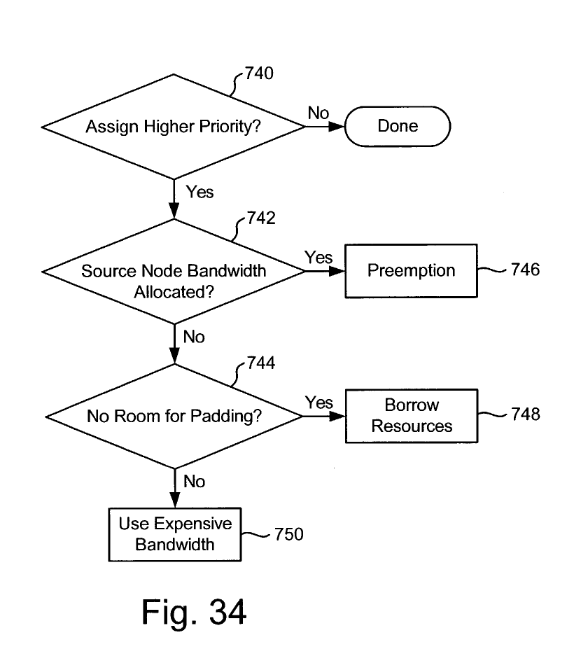

FIG. 34 is a flowchart describing one embodiment of a process for servicing data transfer requests in an environment that supports multiple priority levels.

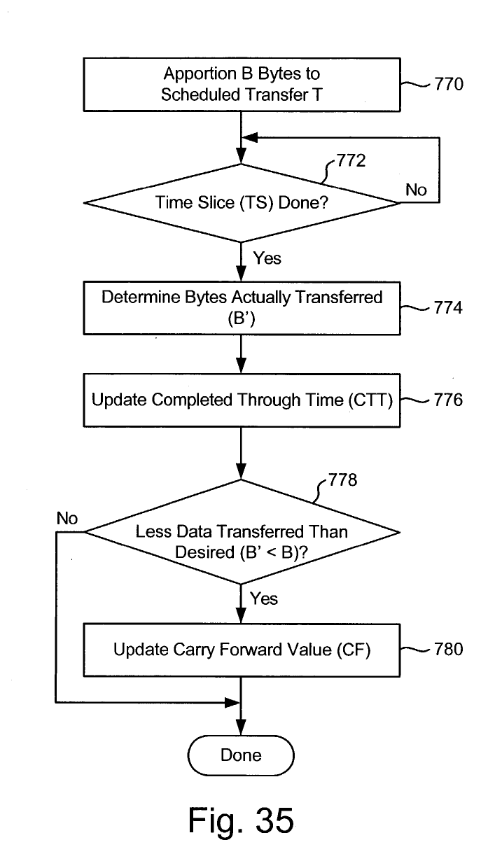

FIG. 35 is a flowchart describing one embodiment of a process for tracking the use of allocated bandwidth.

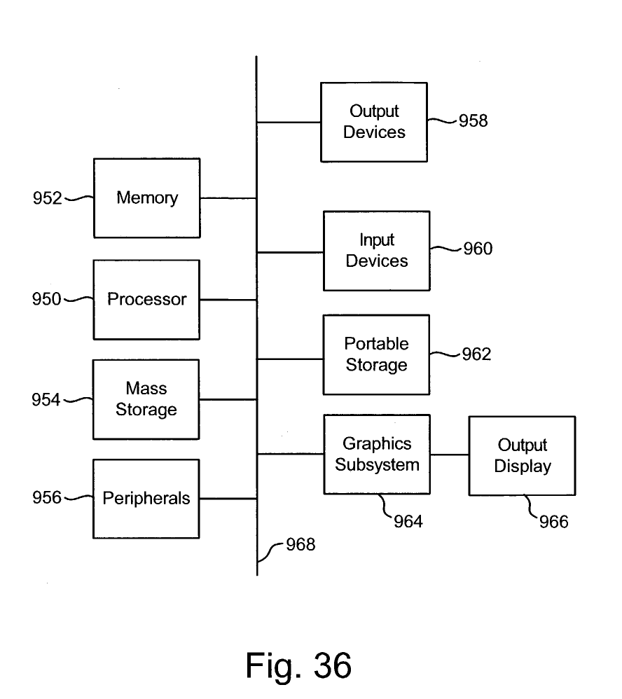

FIG. 36 is a block diagram depicting exemplar components of a computing system that can be used in implementing the present invention.

### DETAILED DESCRIPTION

FIG. 2 is a block diagram of a system that includes a mechanism for providing background delivery of electronic message content in accordance with one implementation of the present invention. In one embodiment, electronic messages include e-mails with attachments, such as electronic files. In further implementations, different types of electronic messages are supported. In one embodiment, network 10, clients 12 and 16 and servers 14 and 18 operate as described above with reference to FIG. 1.

Proxy server 20 is coupled between client 12 and server 14 to facilitate background delivery of electronic message content from client 12. Proxy Server 20 receives outgoing e-mails from client 12, including any attachments in the e-mail. In alternate embodiments, proxy server 20 may not receive all of the attachments—instead, receiving only descriptions of the attachments. Proxy server 20 determines whether e-mail should be delivered to the intended recipient through server 14 or background delivery. If server 14 is selected, proxy server 20 forwards the e-mail to server 14, which delivers the e-mail to the intended recipient as described above with respect to FIG. 1. Otherwise, proxy server 20 arranges for background delivery of content in the e-mail.

Incoming messages from network 10 for e-mail client 12 pass through e-mail server 14, as described above with reference to FIG. 1. In an alternate embodiment, proxy server 20 receives incoming messages from network 10—enabling proxy server 20 to manage the delivery of large incoming messages on a local network connecting e-mail client 12, e-mail server 14, and other e-mail clients. In this implementation, proxy server 20 employs background delivery to pass incoming messages to e-mail server 14.

Proxy server 20 includes receiver 22, splitter 24, and messenger 26, which are each coupled to file system 28 and database 30. File system 28 maintains content slated for background delivery, and database 30 holds meta data associated with electronic message content. Database 30 may be any type of database, and is a relational database in one embodiment. Receiver 22 receives outgoing e-mail from client 12 and stores it in file system 28. Receiver 22 determines whether background delivery is to be employed for each e-mail and updates meta data in database 30 with delivery instructions.

Splitter 24 uses the meta data in database 30 to identify e-mails in file system 28 that are slated for background delivery. Splitter 24 prepares content from the e-mails for background delivery. Splitter 24 also creates notifications for intended e-mail recipients to indicate that content is ready for retrieval. Splitter 24 updates the meta data in database 30 to indicate that notifications are ready to be sent.

Messenger 26 employs meta data in database 28 to identify e-mails in file system 28 that need to be sent. These e-mails include notifications of available content for background delivery and e-mails not meeting the criteria for background delivery. In one embodiment, messenger 26 forwards the e-mails, including notifications, to server 14 for forwarding over network 10. In an alternate embodiment, messenger 26 forwards notifications over network 10 without the use of server 14.

Content transfer client 36, forward proxy, 34, and content proxy 32 are used to transfer content from file system 28 to client 16 in a background delivery. E-mail client 16 receives a notification that content is read to be received from file system 28. Client 16 issues a data transfer request for the content to content transfer client 36, which issues a scheduling request for the content to forward proxy 34. If forward proxy 34 does not have a copy of the content, forward proxy 34 submits a scheduling request for the content to content proxy 32. Content proxy 32 retrieves the content from file system 28 and delivers the content to forward proxy 34, which sends the content to e-mail client 16 through content transfer client 36. In one embodiment, content transfer client 36 is implemented in program code running on the same system as client 16.

In further embodiments, all or multiple e-mail clients have an associated proxy server and content transfer client. Each e-mail client configured in this manner is able to send and receive content through background delivery.

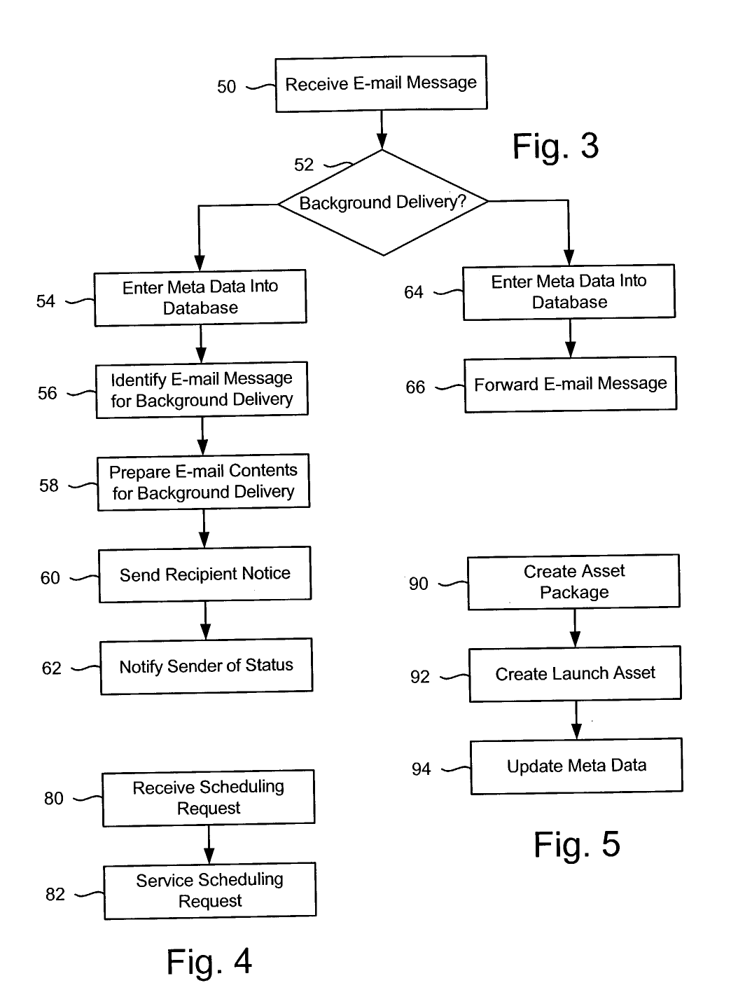

FIG. 3 is a flowchart describing management of electronic message transfers in one embodiment of the present invention. In one implementation, this process is carried out by the network system shown in FIG. 2. Receiver 22 receives an electronic message from client 12 and stores the electronic message in file system 28 (step 50). Receiver 22 determines whether to arrange for background delivery of content associated with the electronic message (step 52). In one implementation, the electronic message is an e-mail and the content includes data from files attached to the e-mail. The content is stored in file system 28 as part of step 50. In alternate embodiments, the content can be data other than attachments, such as other data in the e-mail or other files associated with the electronic message. The electronic message can also be something other than an e-mail.

In determining whether to arrange for background delivery (step 52), proxy server 20 determines whether the received electronic message satisfies a predetermined characteristic. In one embodiment, the predetermined characteristic is the content associated with the electronic message exceeding a size limit. In other embodiments, different characteristics or combinations of characteristics can be employed, such as the network identity of the intended recipient. In a further embodiment, all electronic messages undergo background delivery—eliminating the need for step 52.

If it is determined not to arrange for background delivery (step 52), receiver 22 enters meta data into database 30 indicating that the electronic message is not to be delivered via background delivery (step 64). Messenger 26 sees the meta data indication and forwards the electronic message to server 18 for delivery to the intended recipient (step 66).

If it is determined to arrange for background delivery (step 52), receiver 22 enters meta data into database 30 indicating that the electronic message is to be delivered via background delivery (step 54). Splitter 24 sees the meta data entry and identifies the electronic message as slated for background delivery (step 56). Splitter 24 proceeds to prepare content associated with the electronic message for background delivery (step 58). Greater details regarding the preparation of the contents will be provided below.

After the content is prepared for background delivery, proxy server 20 sends the intended recipient, such as client 16, a notice (step 60). The notice informs client 16 that the content is ready for retrieval. In one implementation, the notice contains content transfer client 36 for use in retrieving the content. Greater details regarding the notice will be provided below.

In one embodiment, proxy server 20 provides status regarding delivery of the content (step 62). This status includes an e-mail in one embodiment and a posting to a user accessible web page in another embodiment. The status allows the sender of the electronic message to track the status of the message.

FIG. 4 is a flowchart describing the background delivery of the contents prepared in step 58. Forward proxy 34 receives a scheduling request calling for the content (step 80). In one implementation, content transfer client 36 issues the scheduling request for delivery of content identified in the notification sent to client 16 by proxy server 20 (step 60, FIG. 3). Forward proxy 34 services the scheduling request (step 82). If forward proxy 34 has the content stored locally, it forwards the content to content transfer client 36, which makes the content available to e-mail client 16. If forward proxy 34 does not have the content stored locally, it makes a scheduling request to content proxy 32, which forwards the data from file system 28 to forward proxy 34. Forward proxy 34 then send the data to content transfer client 36. In some instances, forward proxy 34 is eliminated and content proxy 32 receives the scheduling request directly from content transfer client 36. In further embodiments, multiple forward proxies or content proxies reside in the path of content delivery from file system 28 to content transfer client 36.

In one implementation, each scheduling request includes a bandwidth schedule indicating required delivery specifications for the contents, such as required time for receipt and minimum delivery bandwidth requirements. Forward proxy 34 and content proxy 32 ensure that the requirements from the bandwidth schedule are satisfied, unless this is not possible. In one implementation, forward proxy 34 and content proxy 32 provide the content at the latest time possible that still satisfies the bandwidth schedule. Greater details regarding the performance of receiving and servicing scheduling requests are provided below.

In some instances, forward proxy 34 may receive multiple requests for the same data. Except for the first request, forward proxy 34 can deliver the content from its local memory. This can occur when multiple e-mail clients are the intended recipients of the same content. The intended recipient of the content can also forward the notification relating to the content to another entity. The entity can use the notification to retrieve the content in the same way as the original intended recipient. In one implementation, client 16 forwards the content notification from proxy server 20 in the same way any e-mail is forwarded using e-mail server 18.

FIG. 5 is a flowchart describing one embodiment of a process for preparing contents for background delivery (step 58, FIG. 3). Splitter 24 creates an asset package containing the content (step 90). The package is stored in file system 28. In one implementation, each attachment associated with an electronic message is stored as a separate asset in the package. In alternate embodiments, multiple attachments are combined into a single asset. In some instances, e-mail client 12 groups all attachments together into a single fie that is encoded based on a standardized or proprietary standard. One example of standard encoding is base 64 encoding. In these instances, splitter 24 decodes the attachment grouping and parses out each of the attachments into separate assets as described above.

Splitter 24 also creates a launch asset (step 92). One implementation of a launch asset contains information from the body of the original electronic message and links corresponding to assets in the package. Alternatively, separate links are not provided for each asset. Instead, the launch asset identifies the package assets and contains links that allow a user to accept all assets, reject all assets, or ignore the assets at this time. Some implementations of the launch asset also include program code for implementing content transfer client 36. One version of the launch asset is a Hypertext Markup Language (HTML) document.

Finally, splitter 24 updates meta data in database 30 (step 94). This update indicates that the content has been converted to package assets and is ready to be delivered. In one embodiment, the meta data update sets a lifetime for the package, indicating how long the package will be stored in file system 28.

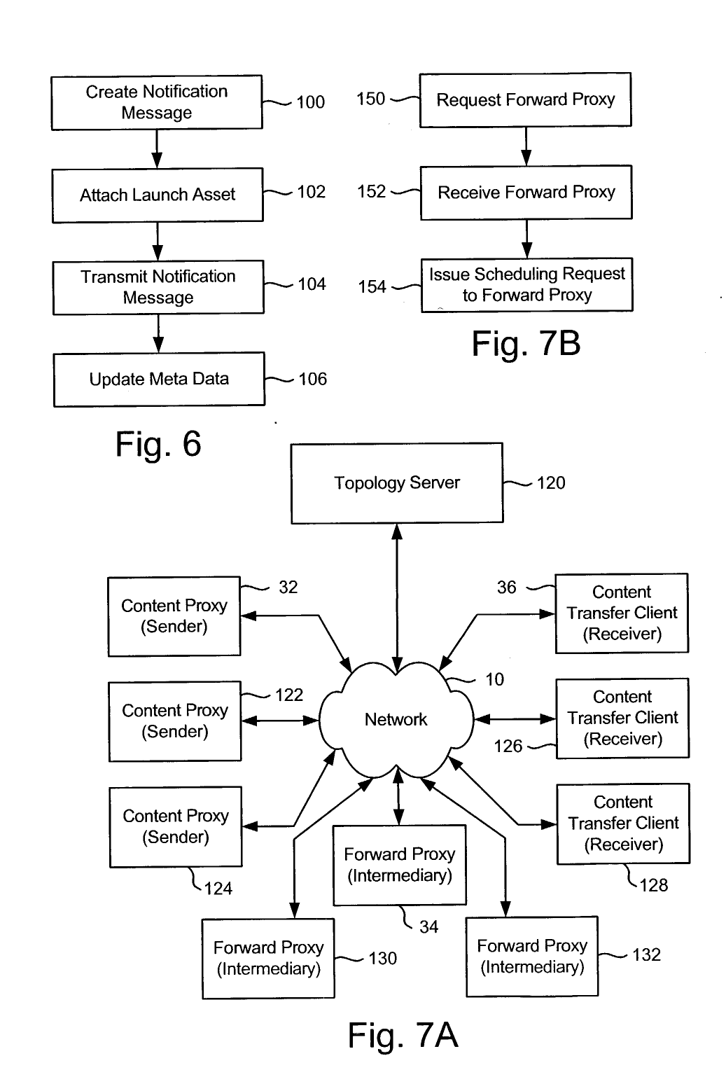

FIG. 6 is a flowchart describing a process for sending a notice to the indicate that electronic message content is ready for retrieval (step 60, FIG. 3). Messenger 26 creates a notification message (step 100). One implementation of the notification message is an e-mail addressed to the intended content recipient. The notification message may include various types of information, including instructions for retrieving the content. Messenger 26 attaches the launch asset to the notification message (step 102). Messenger 26 attaches the launch asset as a traditional e-mail attachment in one embodiment. In other implementations, messenger 26 directly integrates the launch asset into the notification message or provides another type of link between the two.

Messenger 26 transmits the notice, including the notification message and attached launch asset (step 104). Messenger 26 transmits the notice to e-mail server 14 for delivery to the intended recipient over network 10 in one embodiment. Alternatively, messenger 26 transmits the notice directly over network 10 to the intended recipient. Messenger 26 also updates the meta data in database 30 to indicate that the notice has been sent (step 106).

When the notice arrives at the intended content, recipient such as e-mail client 16, the user opens the notice. As described above, one version of the notice's launch asset provides the user with links associated with each asset in the package maintained on file system 28. Selecting a link initiates a process in content transfer client 36 for issuing a scheduling request to retrieve the content asset associated with the link. Alternatively, the launch asset may only allow the user to accept, reject, or ignore all assets. In a further embodiment, a user may not be presented with options in the launch asset. Instead, the launch asset directs content transfer client 36 to automatically initiate the content retrieval process. If the user does not have a content transfer client, the user can install one provided in the launch asset.

FIG. 7A shows a block diagram for a content delivery system implemented on network 10 for supporting multiple proxy servers and e-mail clients. Network 10 links content proxies 32, 122, and 124, content transfer clients 36, 126, and 128, forward proxies 34, 130, and 132, and topology server 120. Content proxies 32, 122, and 124 are each associated with at least one file system, such as a file system 28. Content transfer clients 36, 126, and 128 are each associated with at least one message client, such as e-mail client 16.

Topology server 120 correlates forward proxies 34, 130, and 132 to content transfer clients 36, 126, and 128. When a content transfer client needs to retrieve content, the content transfer client looks to topology server 120 to determine the forward proxy that should receive a scheduling request for the content. This is illustrated by the flowchart in FIG. 7B. When a user selects a link in the launch asset to retrieve content, content transfer client 36 requests a forward proxy from topology server 120 (step 150). Content transfer client 36 receives the identity of a forward proxy from topology server 120 (step 152). Content transfer client 36 then issues a scheduling request for the desired content to the identified forward proxy (step 154).

In FIG. 7A, the content proxies, forward proxies, and content transfer clients are also labeled as senders, intermediaries, and receivers, respectively. These are labels that are employed in describing the operation of these entities below. In short, receivers seek to acquire content. Intermediaries service receiver requests for content by obtaining the content from other entities. Senders have direct access to desired content and provide the content to requesting receivers or intermediaries. Forward proxies also operate as senders when they have local copies of requested content.

Embodiments of the invention have been described above with reference to a proxy server. In alternate embodiments, a client proxy can also be employed. The client proxy runs on the same computer system as the e-mail client and performs the operations described above for receiver 22—allowing receiver 22 to be eliminated from proxy server 20. The client proxy begins buffering outgoing e-mail messages, until it can determine whether background delivery is desired for the message. If background delivery is not desired, the client proxy uploads the stored portion of the message and the remainder of the message to e-mail server 12. Otherwise, the client proxy uploads the message to proxy server 20 for storage in file system 28.

Alternatively, e-mail client 12 can include an add-in that integrates with e-mail client 12 to determine whether to implement background delivery for an electronic message. This is similar to the client proxy, except that the close integration prevents unnecessary grouping and encoding of attachments. As described above, e-mail clients frequently group and encode attachments—requiring proxy server 20 to decode and separate the attachments. The client add-in makes the background delivery determination prior to attachments being grouped and encoded. If background delivery is desired, the client add-in delivers the attachments to proxy server 20 without grouping and encoding—saving proxy server 20 the processing burden of decoding and separating attachments. Using a client add-in also allows for background delivery system options to be presented directly in the e-mail client's graphical user interface.

The following description relating to FIGS. 8A-35 describes operations performed in various embodiments of the present invention to perform background content delivery. This includes the steps of receiving scheduling requests (step 80, FIG. 4) and servicing scheduling requests (step 82, FIG. 4).

FIG. 8A is a block diagram of network nodes operating in different roles according to one embodiment of the present invention. Any node can receive data, send data, or act as an intermediary that passes data from one node to another. In fact, a node may be supporting all or some of these functions simultaneously. In embodiments including virtual nodes, a non-member node that does not exchange scheduling communications operates in tandem with a virtual node to perform receiver, sender, and intermediary functions.

Network 10 connects receiver node 210, sender node 220, and intermediary nodes 230 and 240. In this example, sender 220 is transferring data to receiver 210 through intermediaries 230 and 240. The data can include a variety of information such as text, graphics, video, and audio. Receiver 210 is a computing device, such as a personal computer, set-top box, or Internet appliance, and includes transfer module 212 and local storage 214. Sender 220 is a computing device, such as a web server or other appropriate electronic networking device, and includes transfer module 222. In further embodiments, sender 220 also includes local storage. Intermediaries 230 and 240 are computing devices, such as servers, and include transfer modules 232 and 242 and local storages 234 and 244, respectively.

Transfer modules 212, 222, 232, and 242 facilitate the scheduling of data transfers in accordance with the present invention. In the case of a virtual node, the transfer module for a non-member node that does not exchange scheduling communications is maintained on the virtual node. The virtual node can share the required scheduling information with the non-member node in certain embodiments.

The transfer module at each node evaluates a data transfer request in view of satisfying various objectives. Example objectives include meeting a deadline for completion of the transfer, minimizing the cost of bandwidth, a combination of these two objectives, or any other appropriate objectives. In one embodiment, a transfer module evaluates a data transfer request using known and estimated bandwidths at each node and known and estimated storage space at receiver 210 and intermediaries 230 and 240. A transfer module may also be responsive to a priority assigned to a data transfer. Greater detail regarding transfer module scheduling operations appears below.

FIGS. 8B-8E are block diagrams of different transfer module configurations employed in embodiments of the present invention. FIG. 8B is a block diagram of one embodiment of a transfer module 300 that can be employed in a receiver, sender, or intermediary. Transfer module 300 includes, but is not limited to, admission control module 310, scheduling module 320, routing module 330, execution module 340, slack module 350, padding module 360, priority module 370, and error recovery module 380.

Admission control module 310 receives user requests for data transfers and determines the feasibility of the requested transfers in conjunction with scheduling module 320 and routing module 330. Admission control module 310 queries routing module 330 to identify possible sources of the requested data. Scheduling module 320 evaluates the feasibility of a transfer from the sources identified by routing module 330 and reports back to admission control module 310.

Execution module 340 manages accepted data transfers and works with other modules to compensate for unexpected events that occur during a data transfer. Execution module 340 operates under the guidance of scheduling module 320, but also responds to dynamic conditions that are not under the control of scheduling module 320.

Slack module 350 determines an amount of available resources that should be uncommitted (reserved) in anticipation of differences between actual (measured) and estimated transmission times. Slack module 350 uses statistical estimates and historical performance data to perform this operation. Padding module 360 uses statistical models to determine how close to deadlines transfer module 300 should attempt to complete transfers.

Priority module 370 determines which transfers should be allowed to preempt other transfers. In various implementations of the present invention, preemption is based on priorities given by users, deadlines, confidence of transfer time estimates, or other appropriate criteria. Error recovery module 380 assures that the operations controlled by transfer module 300 can be returned to a consistent state if an unanticipated event occurs.

Several of the above-described modules in transfer module 300 are optional in different applications. FIG. 8C is a block diagram of one embodiment of transfer module 212 in receiver 210. Transfer module 212 includes, but is not limited to, admission control module 310, scheduling module 320, routing module 330, execution module 340, slack module 350, padding module 360, priority module 370, and error recovery module 380. FIG. 8D is a block diagram of one embodiment of transfer module 232 in intermediary 230. Transfer module 232 includes scheduling module 320, routing module 330, execution module 340, slack module 350, padding module 360, and error recovery module 380. FIG. 8E is a block diagram of one embodiment of transfer module 222 in sender 220. Transfer module 222 includes scheduling module 320, execution module 340, slack module 350, padding module 360, and error recovery module 380.

In alternate embodiments, the above-described transfer modules can have many different configurations. Also note that roles of the nodes operating as receiver 210, intermediary 230, and sender 220 can change—requiring their respective transfer modules to adapt their operation for supporting the roles of sender, receiver, and intermediary. For example, in one data transfer a specific computing device acts as intermediary 230 while in another data transfer the same device acts as sender 220. In FIG. 2, forward proxy 34 operates as intermediary 230; content proxy 32 operates as sender 220, and content transfer client 36 operates as receiver 210. When forward proxy 34 has a local copy of requested content it operates as sender 220.

FIG. 9 is a flowchart describing one embodiment of a process employed by transfer module 300 to service user requests for data, such as those issued by e-mail client 16 to content transfer client 36. Admission control module 310 receives a data transfer request from an end user (step 400), like the user of e-mail client 16, and determines whether the requested data is available in a local storage (step 402). If the data is maintained in the computer system containing transfer module 300, admission control module 310 informs the user that the requested is accepted (406) and the data is available (step 416).

If the requested data is not stored locally (step 402), transfer module 300 determines whether the data request can be serviced externally by receiving a data transfer from another node in network 10 (step 404). If the request can be serviced, admission control module 310 accepts the user's data request (step 406). Since the data is not stored locally (step 410), the node containing transfer module 300 receives the data from an external source (step 414), namely the node in network 10 that indicated it would provide the requested data. In one instance, forward proxy 34 provides the data to transfer module 300 in content transfer client 36. The received data satisfies the data transfer request. Once the data is received, admission control module 310 signals the user that the data is available for use.

If the data request cannot be serviced externally (step 404), admission control module 310 provides the user with a soft rejection (408) in one embodiment. In one implementation, the soft rejection suggests a later deadline, higher priority, or a later submission time for the original request. A suggestion for a later deadline is optionally accompanied by an offer of waiting list status for the original deadline. Transfer module 300 determines whether the suggested alternative(s) in the soft rejection is acceptable (step 412). In one implementation, transfer module 300 queries the user. If the alternative(s) is acceptable, transfer module 300 once again determines whether the request can be externally serviced under the alternative condition(s) (step 404). Otherwise, the scheduling process is complete and the request will not be serviced. Alternate embodiments of the present invention do not provide for soft rejections.

FIG. 10 is a flowchart describing one embodiment of a process for providing a soft rejection (step 408). After transfer module 300 determines a request cannot be serviced (step 404), transfer module 300 evaluates the rejection responses from the external data sources (step 430). In one embodiment, these responses include soft rejection alternatives that admission control module 300 provides to the user along with a denial of the original data request (step 432). In alternate embodiments, admission control module 310 only provides the user with a subset of the proposed soft rejection alternatives, based on the evaluation of the responses (step 432).

FIG. 11 is a flowchart describing one embodiment of a process for determining whether a data transfer request is serviceable (step 404, FIG. 9). Transfer module 300 determines whether the node requesting the data, referred to as the receiver, has sufficient resources for receiving the data (step 440). In one embodiment, this includes determining whether the receiver has sufficient data storage capacity and bandwidth for receiving the requested data (step 440). If the receiver's resources are insufficient, the determination is made that the request is not serviceable (step 440).

If the receiver has sufficient resources (step 440), routing module 330 identifies the potential data sources for sending the requested data to the receiver (step 442). In one embodiment, routing module 330 maintains a listing of potential data sources. In another embodiment, routing module 330 in content transfer client 36 queries topology server 120 to obtain the identity of forward proxy 34. Scheduling module 320 selects an identified data source (step 444) and sends the data source an external scheduling request for the requested data (step 446). In one implementation, the external scheduling request identifies the desired data and a deadline for receiving the data. In further implementations, the scheduling request also defines a required bandwidth schedule that must be satisfied by the data source when transmitting the data.

The data source replies to the scheduling request with an acceptance or a denial. If the scheduling request is accepted, scheduling module 320 reserves bandwidth in the receiver for receiving the data (step 450) and informs admission control module 310 that the data request is serviceable. In the case of a virtual node, transfer module 300 reserves bandwidth (step 450) by instructing the associated non-member node to reserve the bandwidth. In alternate virtual node embodiments, the non-member node cannot be instructed to reserve bandwidth.

If the scheduling request is denied, scheduling module 320 determines whether requests have not yet been sent to any of the potential data sources identified by routing module 330 (step452). If there are remaining data sources, scheduling module 320 selects a new data source (step 444) and sends the new data source an external scheduling request (step 446). Otherwise, scheduling module 320 informs admission control module 310 that the request is not serviceable.

FIG. 12 is a flowchart describing one embodiment of a process for servicing an external scheduling request at a potential data source node, such as sender 220 (content proxy 32) or intermediary 230 (forward proxy 34). Transfer module 300 in the data source receives the scheduling request (step 470). In the case of a virtual node, the data source is considered to be the combination of the virtual node and its associated non-member node. The virtual node receives the scheduling request (step 470), since the virtual node contains transfer module 300.

Transfer module 300 determines whether sufficient transmission resources exist for servicing the request (step 472). In one embodiment, scheduling module 300 in the data source determines whether sufficient bandwidth exists for transmitting the requested data (step 472). If the transmission resources are not sufficient, scheduling module 312 denies the scheduling request (step 480). In embodiments using soft rejections, scheduling module 320 also suggests alternative schedule criteria that could make the request serviceable, such as a later deadline.

If the transmission resources are sufficient (step 472) transfer module 300 reserves bandwidth at the data source for transmitting the requested data to the receiver (step 474). Virtual nodes reserve bandwidth by issuing an instruction to an associated non-member node. In some embodiments, bandwidth is not reserved, because the non-member node does not receive instructions from the virtual node.

Transfer module 300 in the data source determines whether the requested data is stored locally (step 476). If the data is stored locally, transfer module 300 informs the receiver that the scheduling request has been accepted (step 482) and transfers the data to the receiver at the desired time (step 490).

If the requested data is not stored locally (step 476), scheduling module 320 in the data source determines whether the data can be obtained from another node (step 478). If the data cannot be obtained, the scheduling request is denied (step 480). Otherwise, transfer module 300 in the data source informs the receiver that the scheduling request is accepted. Since the data is not store locally (step 484), the data source receives the data from another node (step 486) and transfers the data to the receiver at the desired time (step 490).

FIG. 13A is a block diagram of scheduling module 320 in one embodiment of the present invention. Scheduling module 320 includes feasibility test module 500 and preemption module 502. Feasibility test module 500 determines whether sufficient transmission bandwidth exists in a sender or intermediary to service a scheduling request (step 472, FIG. 12). In one embodiment, feasibility test module 500 employs the following information: the identities of sender 220 (or intermediary 230) and receiver 210, the size of the file to transfer, a maximum bandwidth receiver 210 can accept, a transmission deadline, and information about available and committed bandwidth resources. A basic function of feasibility test module 500 includes a comparison of the time remaining before the transfer deadline to the size of the file to transfer divided by the available bandwidth. In alternative embodiments, this basic function is augmented by consideration of the total bandwidth that is already committed to other data transfers. Each of the other data transfers considered includes a file size and expected transfer rate used to calculate the amount of the total bandwidth their transfer will require.

Preemption module 502 is employed in embodiments of the invention that support multiple levels of priority for data requests. More details regarding preemption based on priority levels is provided below.

FIG. 13B is a block diagram of scheduling module 320 in an alternate implementation of the present invention. Scheduling module 320 includes explicit scheduling routine module 504 and preemption module 502. Explicit scheduling routine module 504 also determines whether sufficient transmission bandwidth exists in a sender or intermediary to service a scheduling request (step 472, FIG. 12). Explicit scheduling routine module 504 uses a detailed schedule of uncommitted space and bandwidth resources to make the determination. Greater details regarding explicit scheduling are provided below with reference to FIGS. 24-30.

FIG. 13C is a block diagram of admission control module 310 in one implementation of the present invention. Admission control module 310 includes soft rejection routine module 506 to carry out the soft rejection operations explained above with reference to FIGS. 9 and 10. Admission control module 310 also includes waiting list 508 for tracking rejected requests that are waiting for bandwidth to become available.

FIG. 14 is a flowchart describing one embodiment of a process for determining whether a node will be able to obtain data called for in a scheduling request (step 478, FIG. 12). The steps bearing the same numbers that appear in FIG. 11 operate the same as described above in FIG. 11 for determining whether data can be retrieved to satisfy a data request.

The difference arising in FIG. 14 is the addition of steps to address the situation where multiple nodes request the same data. An intermediary, such as forward proxy 34, may need to service multiple scheduling requests for the same data. The embodiment shown in FIG. 14 enables forward proxy 34 to issue a scheduling request that calls for a single data transfer from content proxy 32. The scheduling request calls for data that satisfies send bandwidth schedules established by forward proxy 34 for transmitting data to multiple content transfer clients (not shown). Nodes other than forward proxy 34 may perform the steps described in FIG. 14. In a general situation, an intermediary identified as node B may need to service multiple scheduling requests for the same data from nodes C and D. In embodiments of the present invention, node B establishes a scheduling request for submission to node A that calls for data to satisfy send bandwidth schedules established by node B for data delivery to nodes C and D. In one example, node B corresponds to forward proxy 34, node A corresponds to content proxy 32, and nodes C and D correspond to content transfer clients, such as content transfer client 36.

Transfer module 300 in node B determines whether multiple nodes are calling for the delivery of the same data from node B (step 520, FIG. 14). If not, transfer module 300 skips to step 440 and carries out the process as described in FIG. 111. In this implementation, the scheduling request issued in step 446 is based on the bandwidth demand of a single node requesting data from node B.

If node B is attempting to satisfy multiple requests for the same data (step 520), scheduling module 310 in node B generates a composite bandwidth schedule (step 522). After the composite bandwidth schedule is generated, transfer module 300 moves to step 440 and carries on the process as described in FIG. 111. In this implementation, the scheduling request issued in step 446 calls for data that satisfies the composite bandwidth schedule.

The composite bandwidth schedule identifies the bandwidth demands a sender or intermediary must meet when providing data to node B, so that node B can service multiple requests for the same data. Further embodiments of the present invention are not limited to only servicing two requests. The principles for servicing two requests for the same data can be extended to any number of requests for the same data.

In one embodiment, node B issues a scheduling request for the composite bandwidth schedule before issuing any individual scheduling requests for the node C and node D bandwidth schedules. In an alternate embodiment, node B generates a composite bandwidth schedule after a scheduling request has been issued for servicing an individual bandwidth schedule for node C or node D. In this case, transfer module 300 instructs the recipient of the individual bandwidth scheduling request that the request has been cancelled. Alternatively, transfer module 300 receives a response to the individual bandwidth scheduling request and instructs the responding node to free the allocated bandwidth. In yet another embodiment, the composite bandwidth is generated at a data source (sender or intermediary) in response to receiving multiple scheduling requests for the same data.

Data transfers can be scheduled as either “store-and-forward” or “flow through” transfers. FIG. 15 employs a set of bandwidth graphs to illustrate the difference between flow through scheduling and store-and-forward scheduling. In one embodiment, a scheduling request includes bandwidth schedule s(t) 530 to identify the bandwidth requirements a sender or intermediary must satisfy over a period of time. In one implementation, this schedule reflects the bandwidth schedule the node issuing the scheduling request will use to transmit the requested data to another node.

Bandwidth schedule r(t) 532 shows a store-and-forward response to the scheduling request associated with bandwidth schedule s(t) 530. In store-and-forward bandwidth schedule 532, all data is delivered to the receiver prior to the beginning of schedule 530. This allows the node that issued the scheduling request with schedule 530 to receive and store all of the data before forwarding it to another entity. In this embodiment, the scheduling request could alternatively identify a single point in time when all data must be received.

Bandwidth schedule r(t) 534 shows a flow through response to the scheduling request associated with bandwidth schedule s(t) 530. In flow through bandwidth schedule 534, all data is delivered to the receiver prior to the completion of schedule 530. Flow through schedule r(t) 534 must always provide a cumulative amount of data greater than or equal to the cumulative amount called for by schedule s(t) 530. This allows the node that issued the scheduling request with schedule s(t) 530 to begin forwarding data to another entity before the node receives all of the data. Greater details regarding the generation of flow through bandwidth schedule r(t) 534 are presented below with reference to FIGS. 24-26.

FIG. 16 is a set of bandwidth graphs illustrating one example of flow through scheduling for multiple end nodes in one embodiment of the present invention. Referring back to FIG. 3, bandwidth schedule c(t) represents a schedule node B set for delivering data to node C. Bandwidth schedule d(t) 536 represents a bandwidth schedule node B set for delivering the same data to node D. Bandwidth schedule r(t) 540 represents a flow through schedule node A set for delivering data to node B for servicing schedules c(t) 536 and d(t) 538. In one embodiment of the present invention, node A generates r(t) 540 in response to a composite bandwidth schedule based on schedules c(t) 536 and d(t) 538, as explained above in FIG. 14 (step 522). Although r(t) 540 has the same shape as d(t) 538 in FIG. 16, r(t) 540 may have a shape different than d(t) 538 and c(t) 536 in further examples.

FIG. 17 is a flowchart describing one embodiment of a process for generating a composite bandwidth schedule (step 522, FIG. 14). In this embodiment, bandwidth schedules are generated as step functions. In alternate embodiments, bandwidth schedules can have different formats. Scheduling module 320 selects an interval of time (step 550). For each selected interval, each of the multiple bandwidth schedules for the same data, such as c(t) 536 and d(t) 538, have a constant value (step 550). Scheduling module 320 sets one or more values for the composite bandwidth schedule in the selected interval (step 552). Scheduling module 300 determines whether any intervals remain unselected (step 554). If any intervals remain unselected, scheduling module 320 selects a new interval (step 550) and determines one or more composite bandwidth values for the interval (step 552). Otherwise, the composite bandwidth schedule is complete.

FIG. 18 is a flowchart describing one embodiment of a process for setting composite bandwidth schedule values within an interval (step 552, FIG. 18). The process shown in FIG. 18 is based on servicing two bandwidth schedules, such as c(t) 536 and d(t) 538. In alternate embodiments, additional schedules can be serviced.

The process in FIG. 18 sets values for the composite bandwidth schedule according to the following constraint: the amount of cumulative data called for by the composite bandwidth schedule is never less than the largest amount of cumulative data required by any of the individual bandwidth schedules, such as c(t) 536 and d(t) 538. In one embodiment, the composite bandwidth schedule is generated so that the amount of cumulative data called for by the composite bandwidth schedule is equal to the largest amount of cumulative data required by any of the individual bandwidth schedules. This can be expressed as follows for servicing two individual bandwidth schedules, c(t) 536 and d(t) 538:

$$cb ( t ) = \frac{ⅆ}{ⅆ t} [ max ( C ( t ) , D ( t ) ) ]$$

Wherein:
cb(t) is the composite bandwidth schedule;
t is time;
max ( ) is a function yielding the maximum value in the parentheses;

$$C ( t ) = {\int }_{- ∞}^{t} c ( t ) ⅆ t$$

(representing the cumulative data demanded by bandwidth schedule c(t) 536); and

$$D ( t ) = {\int }_{- ∞}^{t} d ( t ) ⅆ t$$

(representing the cumulative data demanded by bandwidth schedule d(t) 538).

This relationship allows the composite bandwidth schedule cb(t) to correspond to the latest possible data delivery schedule that satisfies both c(t) 536 and d(t) 538.

At some points in time, C(t) may be larger than D(t). At other points in time, D(t) may be larger than C(t). In some instances, D(t) and C(t) may be equal. Scheduling module 320 determines whether there is a data demand crossover within the selected interval (step 560, FIG. 18). A data demand crossover occurs when C(t) and D(t) go from being unequal to being equal or from being equal to being unequal. When this occurs, the graphs of C(t) and D(t) cross at a time in the selected interval.

When a data demand crossover does not occur within a selected interval, scheduling module 320 sets the composite bandwidth schedule to a single value for the entire interval (step 566). If C(t) is larger than D(t) throughout the interval, scheduling module 320 sets the single composite bandwidth value equal to the bandwidth value of c(t) for the interval. If D(t) is larger than C(t) throughout the interval, scheduling module 320 sets the composite bandwidth value equal to the bandwidth value of d(t) for the interval. If C(t) and D(t) are equal throughout the interval, scheduling module 320 sets the composite bandwidth value to the bandwidth value of d(t) or c(t)—they will be equal under this condition.

When a data demand crossover does occur within a selected interval, scheduling module 320 identifies the time in the interval when the crossover point of C(t) and D(t) occurs (step 562). FIG. 19 illustrates a data demand crossover point occurring within a selected interval spanning from time x to time x+w. Line 570 represents D(t) and line 572 represents C(t). In the selected interval, D(t) and C(t) cross at time x+Q, where Q is an integer. Alternatively, a crossover may occur at a non-integer point in time.

In one embodiment, scheduling module 320 identifies the time of the crossover point as follows:
Q=INT[(c_{—}oldint−d_{—}oldint)/(d(x)−c(x))]; and
RM=(c_{—}oldint−d_{—}oldint)−Q*(d(x)−c(x))
Wherein:
Q is the integer crossover point;
INT[ ] is a function equal to the integer portion of the value in the brackets;
RM is the remainder from the division that produced Q, where t=x+Q+(RM/(c_oldint−d_oldint)) is the crossing point of D(t) and C(t) within the selected interval;

$$c\_old int = {\int }_{- ∞}^{x} c ( t ) ⅆ t$$

(representing the y-intercept value for line 572);

$$d\_old int = {\int }_{- ∞}^{x} d ( t ) ⅆ t$$

(representing the y-intercept value for line 570);
x is the starting time of the selected interval;
w is the time period of the selected interval;
c(x) is the slope of line 572; and
d(x) is the slope of line 570.

Scheduling module 320 employs the crossover point to set one or more values for the composite bandwidth schedule in the selected interval (step 564).

FIG. 20 is a flowchart describing one embodiment of a process for setting values for the composite bandwidth schedule within a selected interval (step 564, FIG. 18). Scheduling module 320 determines whether the integer portion of the crossover occurs at the start point of the interval—meaning Q equals 0 (step 580). If this is the case, scheduling module 300 determines whether the interval is a single unit long—meaning w equals 1 unit of the time measurement being employed (step 582). In the case of a single unit interval, scheduling module 320 sets a single value for the composite bandwidth within the selected interval (step 586). In one embodiment, this value is set as follows:
For x<=t<x+1: cb(t) equals the slope of the data demand line with the greatest value at the end of the interval less the remainder value RM.

If the interval is not a single unit (step 582), scheduling module 320 sets two values for the composite bandwidth schedule within the selected interval (step 590). In one embodiment, these values are set as follows:
For x<=t<x+1: cb(t) equals the slope of the data demand line with the greatest value at the end of the interval less the remainder value RM; and
For x+1<=t<x+w: cb(t) equals the slope of the data demand line with the greatest value at the end of the interval.

If the integer portion of the crossover does not occur at the starting point of the interval (step 580), scheduling module 320 determines whether the integer portion of the crossover occurs at the end point of the selected interval—meaning Q>0 and Q+1=w (step 584). If this is the case, scheduling module 320 sets two values for the composite bandwidth schedule within the interval (step 588). In one embodiment, these values are set as follows:
For x<=t<x+Q: cb(t) equals the slope of the data demand line with the lowest value at the end of the interval; and
For x+Q<=t<x+w: cb(t) equals the slope of the data demand line with the greatest value at the end of the interval less the remainder value RM.

If the integer portion of the crossover is not an end point (step 584), scheduling module 320 sets three values for the composite bandwidth schedule in the selected interval (step 600). In one embodiment, these values are set as follows:
For x<=t<x+Q: cb(t) equals the slope of the data demand line with the lowest value at the end of the interval;
For x+Q<=t<x+Q+1: cb(t) equals the slope of the data demand line with the greatest value at the end of the interval less the remainder value RM; and
For x+Q+1<=t<x+w: cb(t) equals the slope of the data demand line with the greatest value at the end of the interval.

By applying the above-described operations, the data demanded by the composite bandwidth schedule during the selected interval equals the total data required for servicing the individual bandwidth schedules, c(t) and d(t). In one embodiment, this results in the data demanded by the composite bandwidth schedule from the beginning of time through the selected interval to equal the largest cumulative amount of data specified by one of the individual bandwidth schedules through the selected interval. In mathematical terms, for the case where a crossover exists between C(t) and D(t) within the selected interval and D(t) is larger than C(t) at the end of the interval:

$${\int }_{x}^{x + w} cb ( t ) ⅆ t = {\int }_{x}^{x + w} d ( t ) ⅆ t - {\int }_{x}^{x + w} c ( t ) ⅆ t$$

FIG. 21 is a graph showing one example of values set for the composite bandwidth schedule in the selected interval in step 600 (FIG. 20) using data demand lines 570 and 572 in FIG. 19. In this example, c_oldint=80, d_oldint=72, x=0, w=5, c(0)=1, and d(0)=5. This results in the following:
Q=INT[(80−72)/(5−1)]=2
RM=(80−72)−2*(5−1)=0
For 0<=t<2: cb(t)=1;
For 2<=t<3: cb(t)=5−0=5; and
For 3<=t<5: cb(t)=5.

Composite bandwidth schedule 574 in FIG. 21 reflects the above-listed value settings in the selected interval.

FIG. 22 illustrates a non-integer data demand crossover point occurring within a selected interval spanning from time x to time x+w. Line 571 represents D(t) and line 573 represents C(t). In the selected interval, D(t) and C(t) cross at time x+Q+(RM/(d(x)−c(x)).

FIG. 23 is a graph showing one example of values set for the composite bandwidth schedule in the selected interval in step 600 (FIG. 20) using data demand lines 571 and 573 in FIG. 22. In this example, c_oldint=80, d_oldint=72, x=0, w=5, c(0)=2, and d(0)=5. This results in the following:
Q=INT[(80−72)/(5−2)]=2
RM=(80−72)−2*(5−2)=2
For 0<=t<2: cb(t)=2;
For 2<=t<3: cb(t)=5−2=3; and
For 3<=t<5: cb(t)=5.

FIG. 24 is a flowchart describing one embodiment of a process for determining whether sufficient transmission bandwidth exists at a data source (sender or intermediary) to satisfy a scheduling request (step 472, FIG. 12). In one embodiment, this includes the generation of a send bandwidth schedule r(t) that satisfies the demands of a bandwidth schedule s(t) associated with the scheduling request. In one implementation, as described above, the scheduling request bandwidth schedule s(t) is a composite bandwidth schedule cb(t).

Scheduling module 320 in the data source considers bandwidth schedule s(t) and constraints on the ability of the data source to provide data to the requesting node. One example of such a constraint is limited availability of transmission bandwidth. In one implementation, the constraints can be expressed as a constraint bandwidth schedule cn(t). In this embodiment, bandwidth schedules are generated as step functions. In alternate embodiments, bandwidth schedules can have different formats.

Scheduling module 320 selects an interval of time where bandwidth schedules s(t) and cn(t) have constant values (step 630). In one embodiment, scheduling module 320 begins selecting intervals from the time at the end of scheduling request bandwidth schedule s(t)—referred to herein as s_end. The selected interval begins at time x and extends for all time before time x+w—meaning the selected interval is expressed as x <=t<x+w. In one implementation, scheduling module 320 determines the values for send bandwidth schedule r(t) in the time period x+w<=t<s_end before selecting the interval x<=t<x+w.

Scheduling module 320 sets one or more values for the send bandwidth schedule r(t) in the selected interval (step 632). Scheduling module 300 determines whether any intervals remain unselected (step 634). In one implementation, intervals remain unselected as long the requirements of s(t) have not yet been satisfied and the constraint bandwidth schedule is non-zero for some time not yet selected.

If any intervals remain unselected, scheduling module 320 selects a new interval (step 630) and determines one or more send bandwidth values for the interval (step 632). Otherwise, scheduling module 320 determines whether the send bandwidth schedule meets the requirements of the scheduling request (step 636). In one example, constraint bandwidth schedule cn(t) may prevent the send bandwidth schedule r(t) from satisfying scheduling request bandwidth schedule s(t). If the scheduling request requirements are met (step 636), sufficient bandwidth exists and scheduling module 320 reserves transmission bandwidth (step 474, FIG. 12) corresponding to send bandwidth schedule r(t). Otherwise, scheduling module 320 reports that there is insufficient transmission bandwidth.

FIG. 25 is a flowchart describing one embodiment of a process for setting send bandwidth schedule values within an interval (step 632, FIG. 24). The process shown in FIG. 25 is based on meeting the following conditions: (1) the final send bandwidth schedule r(t) is always less than or equal to constraint bandwidth schedule cn(t); (2) data provided according to the final send bandwidth schedule r(t) is always greater than or equal to data required by scheduling request bandwidth schedule s(t); and (3) the final send bandwidth schedule r(t) is the latest send bandwidth schedule possible, subject to conditions (1) and (2).

For the selected interval, scheduling module 320 initially sets send bandwidth schedule r(t) equal to the constraint bandwidth schedule cn(t) (step 640). Scheduling module 320 then determines whether the value for constraint bandwidth schedule cn(t) is less than or equal to scheduling request bandwidth schedule s(t) within the selected interval (step 641). If so, send bandwidth schedule r(t) remains set to the value of constraint bandwidth schedule cn(t) in the selected interval. Otherwise, scheduling module 320 determines whether a crossover occurs in the selected interval (642).

A crossover may occur within the selected interval between the values R(t) and S(t), as described below:

$$R ( t ) = {\int }_{t}^{x + w} cn ( v ) ⅆ v + {\int }_{x + w}^{s\_end} r ( v ) ⅆ v$$

(representing the accumulated data specified by send bandwidth schedule r(t) as initially set, in a range spanning the beginning of the selected interval through spend); and

$$S ( t ) = {\int }_{t}^{s\_end} s ( v ) ⅆ v$$

(representing the accumulated data specified by scheduling request bandwidth schedule s(t) in a range spanning the beginning of the selected interval through s_end).

A crossover occurs when the lines defined by R(t) and S(t) cross. When a crossover does not occur within the selected interval, scheduling module 320 sets send bandwidth schedule r(t) to the value of constraint bandwidth schedule cn(t) for the entire interval (step 648).

When a crossover does occur within a selected interval, scheduling module 320 identifies the time in the interval when the crossover point occurs (step 644). FIG. 26 illustrates an accumulated data crossover point occurring within a selected interval (x<=t<x+w). Line 650 represents the R(t) that results from initially setting r(t) to cn(t) in step 640 (FIG. 25). Line 652 represents S(t). In the selected interval, R(t) and S(t) cross at time x+w−Q, where Q is an integer. Alternatively, a crossover may occur at a non-integer point in time.

In one embodiment, scheduling module 300 identifies the time of the crossover point as follows:
Q=INT[(s_{—}oldint−r_{—}oldint)/(cn(x)−s(x))]; and
RM=(s_{—}oldint−r_{—}oldint)−Q*(cn(x)−s(x))
Wherein:
Q is the integer crossover point;
RM is the remainder from the division that produced Q, where t=x+w−Q−(RM/(s_oldint−r_oldint)) is the crossing point of R(t) and S(t) within the selected interval;

$$s\_old int = {\int }_{x + w}^{s\_end} s ( t ) ⅆ t$$

(representing the y-intercept value for line 652);

$$r\_old int = {\int }_{x + w}^{s\_end} r ( t ) ⅆ t$$

(representing the y-intercept value for line 650);
x is the starting time of the selected interval;
w is the time period of the selected interval;
−cn(x) is the slope of line 650; and
−s(x) is the slope of line 652.

Scheduling module 320 employs the crossover point to set one or more final values for send bandwidth schedule r(t) in the selected interval (step 646, FIG. 25).

FIG. 27 is a flowchart describing one embodiment of a process for setting final values for send bandwidth schedule r(t) within a selected interval (step 646, FIG. 25). Scheduling module 320 determines whether the integer portion of the crossover occurs at the end point of the interval—meaning Q equals 0 (step 660). If this is the case, scheduling module 320 determines whether the interval is a single unit long—meaning w equals 1 unit of the time measurement being employed (step 662). In the case of a single unit interval, scheduling module 320 sets a single value for send bandwidth schedule r(t) within the selected interval (step 666). In one embodiment, this value is set as follows:
For x<=t<x+w: r(t) equals the sum of the absolute value of the slope of accumulated data line S(t) and the remainder value RM—meaning r(t)=s(x)+RM.

If the interval is not a single unit (step 662), scheduling module 320 sets two values for send bandwidth schedule r(t) within the selected interval (step 668). In one embodiment, these values are set as follows:
For x<=t<x+w−1: r(t) equals the absolute value of the slope of accumulated data line S(t)—meaning r(t)=s(x); and
For x+w−1<=t<x+w: r(t) equals the sum of the absolute value of the slope of accumulated data line S(t) and the remainder value RM—meaning r(t)=s(x)+RM.

If the integer portion of the crossover does not occurs at the end point of the interval (step 660), scheduling module 320 determines whether the integer portion of the crossover occurs at the start point of the selected interval—meaning Q>0 and Q+1=w (step 664). If this is the case, scheduling module 320 sets two values for send bandwidth schedule r(t) within the selected interval (step 670). In one embodiment, these values are set as follows:
For x<=t<x+1: r(t) equals the sum of the absolute value of the slope of accumulated data line S(t) and the remainder value RM —meaning r(t)=s(x)+RM; and
For x+1<=t<x+w: r(t) equals the constraint bandwidth schedule—meaning r(t)=cn(x).

If the integer portion of the crossover is not a start point (step 664), scheduling module 320 sets three values for send bandwidth schedule r(t) in the selected interval (step 670). In one embodiment, these values are set as follows:
For x<=t<x+w−Q−1: r(t) equals the absolute value of the slope of accumulated data line S(t)—meaning r(t)=s(x);
For x+w−Q−1<=t<x+w−Q: r(t) equals the sum of the absolute value of the slope of accumulated data line S(t) and the remainder value RM—meaning r(t)=s(x)+RM; and
For x+w−Q<=t<x+w: r(t) equals the constraint bandwidth schedule meaning r(t)=cn(x).

By applying the above-described operations, send bandwidth schedule r(t) provides data that satisfies scheduling request bandwidth schedule s(t) as late as possible. In one embodiment, where cn(t)>s(t) for a selected interval, the above-described operations result in the cumulative amount of data specified by r(t) from s_end through the start of the selected interval (x) to equal the cumulative amount of data specified by s(t) from s_end through the start of the selected interval (x).

FIG. 28 is a graph showing one example of values set for the send bandwidth schedule in the selected interval in step 672 (FIG. 27) using accumulated data lines 652 and 650 in FIG. 26. In this example, s_oldint=80, r_oldint=72, x=0, w=5, s(x)=1, and cn(x)=5. This results in the following:
Q=INT[(80−72)/(5−1)]=2
RM=(80−72)−2*(5−1)=0
For 0<=t<2: r(t)=1;
For 2<=t<3: r(t)=1+0=1; and
For 3<=t<5: r(t)=5.

Send bandwidth schedule 654 in FIG. 28 reflects the above-listed value settings in the selected interval.

FIG. 29 illustrates a non-integer data demand crossover point occurring within a selected interval spanning from time x to time x+w. Line 653 represents S(t) and line 651 represents R(t) with the initial setting of r(t) to cn(t) in the selected interval. In the selected interval, S(t) and R(t) cross at time x+w−Q−(RM/(cn(x)−s(x)).

FIG. 30 is a graph showing one example of values set for send bandwidth schedule r(t) in the selected interval in step 672 (FIG. 207) using accumulated data lines 653 and 651 in FIG. 29. In this example, s_oldint=80, r_oldint=72, x=0, w=5, cn(x)=5, and s(x)=2. This results in the following:
Q=INT[(80−72)/(5−2)]=2
RM=(80−72)−2*(5−2)=2
For 0<=t<2: r(t)=2;
For 2<=t<3: r(t)=2+2=4; and
For 3<=t<5: r(t)=5.

Some embodiments of the present invention employ forward and reverse proxies. A forward proxy is recognized by a node that desires data from a data source as a preferable alternate source for the data. If the node has a forward proxy for desired data, the node first attempts to retrieve the data from the forward proxy. A reverse proxy is identified by a data source in response to a scheduling request as an alternate source for requested data. After receiving the reverse proxy, the requesting node attempts to retrieve the requested data from the reverse proxy instead of the original data source. A node maintains a redirection table that correlates forward and reverse proxies to data sources, effectively converting reverse proxies into forward proxies for later use. Using the redirection table avoids the need to receive the same reverse proxy multiple times from a data source. In alternate embodiments of the system in FIG. 2, forward proxy 34 can be replaced with a reverse proxy or a node that is neither a forward proxy or a reverse proxy.

FIG. 31 is a flowchart describing an alternate embodiment of a process for determining whether a data transfer request is serviceable, using proxies. The steps with the same numbers used in FIGS. 11 and 14 operate as described above with reference to FIGS. 11 and 14. In further embodiments, the process shown in FIG. 31 also includes the steps shown in FIG. 14 for generating a composite bandwidth schedule for multiple requests.

In order to handle proxies, the process in FIG. 31 includes the step of determining whether a reverse proxy is supplied (step 690) when an external scheduling is denied (step 448). If a reverse proxy is not supplied, transfer module 300 determines whether there are any remaining data sources (step 452). Otherwise, transfer module 300 updates the node's redirection table with the reverse proxy (step 692) and issues a new scheduling request to the reverse proxy for the desired data (step 446). In one embodiment, the redirection table update (step 692) includes listing the reverse proxy as a forward proxy for the node that returned the reverse proxy.

FIG. 32 is a flowchart describing one embodiment of a process for selecting a data source (step 444, FIGS. 11, 14, and 31), using proxies. Transfer module 300 determines whether there are any forward proxies associated with the desired data that have not yet been selected (step 700). If so, transfer module 300 selects one of the forward proxies as the desired data source (step 704). In one embodiment, transfer module 300 employs the redirection table to identify forward proxies. In one such embodiment, the redirection table identifies a data source and any forward proxies associated with the data source for the requested data. If no forward proxies are found, transfer module 300 selects a non-proxy data source as the desired sender (step 702). In some embodiments, the list of forward proxies is maintained on topology server 120. In other embodiments, the list can be maintained locally.

FIG. 33 is a flowchart describing an alternate embodiment of a process for servicing data transfer requests when preemption is allowed. The steps with the same numbers used in FIG. 9 operate as described above with reference to FIG. 9. Once a data request has been rendered unserviceable (step 412), transfer module 300 determines whether the request could be serviced by preempting a transfer from a lower priority request (step 720).

Priority module 370 (FIG. 8B) is included in embodiments of transfer module 300 that support multiple priority levels. In one embodiment, priority module 370 uses the following information to determination whether preemption is warranted (step 720): (1) information about a request (requesting node, source node, file size, deadline), (2) information about levels of service available at the requesting node and the source node, (3) additional information about cost of bandwidth, and (4) a requested priority level for the data transfer. In further embodiments, additional or alternate information can be employed.

If preemption of a lower priority transfer will not allow a request to be serviced (step 720), the request is finally rejected (step 724). Otherwise, transfer module 300 preempts a previously scheduled transfer so the current request can be serviced (step 722). In one embodiment, preemption module 502 (FIGS. 13A and 13B) finds lower priority requests that have been accepted and whose allocated resources are relevant to the current higher priority request. The current request then utilizes the bandwidth and other resources formerly allocated to the lower priority request. In one implementation, a preemption results in the previously scheduled transfer being cancelled. In alternate implementations, the previously scheduled transfer is rescheduled to a later time.

Transfer module 300 determines whether the preemption causes a previously accepted request to miss a deadline (step 726). Fox example, the preemption may cause a preempted data transfer to fall outside a specified window of time. If so, transfer module 300 notifies the data recipient of the delay (step 728). In either case, transfer module 300 accepts the higher priority data transfer request (step 406) and proceeds as described above with reference to FIG. 9.

In further embodiments, transfer module 300 instructs receiver scheduling module 320 to poll source nodes of accepted transfers to update their status. Source node scheduling module 320 replies with an OK message (no change in status), a DELAYED message (transfer delayed by some time), or a CANCELED message.

FIG. 34 is a flowchart describing one embodiment of a process for servicing data transfer requests in an environment that supports multiple priority levels. All or some of this process may be incorporated in step 404 and/or step 720 (FIG. 33) in further embodiments of the present invention. Priority module 370 (FIG. 8B) determines whether the current request is assigned a higher priority than any of the previous requests (step 740). In one embodiment, transfer module 300 queries a user to determine whether the current request's priority should be increased to allow for preemption. For example, priority module 370 gives a user requesting a data transfer an option of paying a higher price to assign a higher priority to the transfer. If the user accepts this option, the request has a higher priority and has a greater chance of being accepted.

If the assigned priority of the current request is not higher than any of the scheduled transfers (step 740), preemption is not available. Otherwise, priority module 370 determines whether the current request was rejected because all transmit bandwidth at the source node was already allocated (step 742). If so, preemption module 502 preempts one or more previously accepted transfers from the source node (step 746). If not, priority module 370 determines whether the current request was rejected because there was no room for padding (step 744). If so, preemption module 502 borrows resources from other transfers at the time of execution in order to meet the deadline. If not, preemption module 502 employs expensive bandwidth that is available to requests with the priority level of the current request (step 750). In some instances, the available bandwidth may still be insufficient.

FIG. 35 is a flowchart describing one embodiment of a process for tracking the use of allocated bandwidth. When scheduling module 320 uses explicit scheduling routine 504, the apportiomnent of available bandwidth to a scheduled transfer depends upon the details of the above-described bandwidth schedules. In one embodiment, a completed through time (CTT) is associated with a scheduled transfer T. CTT serves as a pointer into the bandwidth schedule transfer T.

For a time slice of length TS, execution module 330 apportions B bytes to transfer T (step 770), where B is the integral of the bandwidth schedule from CTT to CTT+TS. After detecting the end of time slice TS (step 772), execution module 340 determines the number of bytes actually transferred, namely B′ (step 774). Execution module 340 then updates CTT to a new value, namely CTT′ (step 776), where the integral from CTT to CTT′ is B′.

At the end of time slice TS, execution module 340 determines whether the B′ amount of data actually transferred is less than the scheduled B amount of data (step 778). If so, execution module 340 updates a carry forward value CF to a new value CF′, where CF′=CF+B−B′. Otherwise, CF is not updated. The carry forward value keeps track of how many scheduled bytes have not been transferred.

Any bandwidth not apportioned to other scheduled transfers can be used to reduce the carry forward. Execution module 340 also keeps track of which scheduled transfers have been started or aborted. Transfers may not start as scheduled either because space is not available at a receiver or because the data is not available at a sender. Bandwidth planned for use in other transfers that have not started or been aborted is also available for apportionment to reduce the carry forward.

As seen from FIG. 35, execution module 340 is involved in carrying out a node's scheduled transfers. In one embodiment, every instance of transfer module 300 includes execution module 340, which uses information stored at each node to manage data transfers. This information includes a list of accepted node-to-node transfer requests, as well as information about resource reservations committed by scheduling module 320.

Execution module 340 is responsible for transferring data at the scheduled rates. Given a set of accepted requests and a time interval, execution module 340 selects the data and data rates to employ during the time interval. In one embodiment, execution module 340 uses methods as disclosed in the co-pending application entitled “System and Method for Controlling Data Transfer Rates on a Network.”

The operation of execution module 340 is responsive to the operation of scheduling module 320. For example, if scheduling module 320 constructs explicit schedules, execution module 340 attempts to carry out the scheduled data transfers as close as possible to the schedules. Alternatively, execution module 340 performs data transfers as early as possible, including ahead of schedule. If scheduling module 320 uses feasibility test module 502 to accept data transfer request, execution module 340 uses the results of those tests to prioritize the accepted requests.

As shown in FIG. 35, execution module 340 operates in discrete time slice intervals of length TS. During any time slice, execution module 340 determines how much data from each pending request should be transferred from a sender to a receiver. Execution module 340 determines the rate at which the transfer should occur by dividing the amount of data to be sent by the length of the time slice TS. If scheduling module 320 uses explicit scheduling routine 504, there are a number of scheduled transfers planned to be in progress during any time slice. There may also be transfers that were scheduled to complete before the current time slice, but which are running behind schedule. In further embodiments, there may be a number of dynamic requests receiving service, and a number of dynamic requests pending.

Execution module 340 on each sender apportions the available transmit bandwidth among all of these competing transfers. In some implementations, each sender attempts to send the amount of data for each transfer determined by this apportionment. Similarly, execution module 340 on each receiver may apportion the available receive bandwidth among all the competing transfers. In some implementations, receivers control data transfer rates. In these implementations, the desired data transfer rates are set based on the amount of data apportioned to each receiver by execution module 340 and the length of the time slice TS.

In other implementations, both a sender and receiver have some control over the transfer. In these implementations, the sender attempts to send the amount of data apportioned to each transfer by its execution module 340. The actual amount of data that can be sent, however, may be restricted either by rate control at a receiver or by explicit messages from the receiver giving an upper bound on how much data a receiver will accept from each transfer.

Execution module 340 uses a dynamic request protocol to execute data transfers ahead of schedule. One embodiment of the dynamic request protocol has the following four message types:
DREQ(id, start, rlimit, Dt);
DGR(id, rlimit);
DEND_RCV(id, size); and
DEND_XMIT(id, size, Dt).

DREQ(id, start, rlimit, Dt) is a message from a receiver to a sender calling for the sender to deliver as much as possible of a scheduled transfer identified by id. The DREQ specifies for the delivery to be between times start and start+Dt at a rate less than or equal to rlimit. The receiver reserves rlimit bandwidth during the time interval from start to start+Dt for use by this DREQ. The product of the reserved bandwidth, rlimit, and the time interval, Dt, must be greater than or equal to a minimum data size BLOCK. The value of start is optionally restricted to values between the current time and a fixed amount of time in the future. The DREQ expires if the receiver does not get a data or message response from the sender by time start+Dt.

DGR(id, rlimit) is a message from a sender to a receiver to acknowledge a DREQ message. DGR notifies the receiver that the sender intends to transfer the requested data at a rate that is less than or equal to rlimit. The value of rlimit used in the DGR command must be less than or equal to the limit of the corresponding DREQ.

DEND_RCV(id, size) is a message from a receiver to a sender to inform the sender to stop sending data requested by a DREQ message with the same id. DEND also indicates that the receiver has received size bytes.

DEND_XMIT(id, size, Dt) is a message from a sender to a receiver to signal that the sender has stopped sending data requested by a DREQ message with the same id, and that size bytes have been sent. The message also instructs the receiver not to make another DREQ request to the sender until Dt time has passed. In one implementation, the message DEND_XMIT(id, 0, Dt) is used as a negative acknowledgment of a DREQ.

A transfer in progress and initiated by a DREQ message cannot be preempted by another DREQ message in the middle of a transmission of the minimum data size BLOCK. Resource reservations for data transfers are canceled when the scheduled data transfers are completed prior to their scheduled transfer time. The reservation cancellation is done each time the transfer of a BLOCK of data is completed.

If a receiver has excess receive bandwidth available, the receiver can send a DREQ message to a sender associated with a scheduled transfer that is not in progress. Transfers not in progress and with the earliest start time are given the highest priority. In systems that include time varying cost functions for bandwidth, the highest priority transfer not in progress is optionally the one for which moving bandwidth consumption from the scheduled time to the present will provide the greatest cost savings. The receiver does not send a DREQ message unless it has space available to hold the result of the DREQ message until its expected use (i.e. the deadline of the scheduled transfer).

If a sender has transmit bandwidth available, and has received several DREQ messages requesting data transfer bandwidth, the highest priority DREQ message corresponds to the scheduled transfer that has the earliest start time. The priority of DREQ messages for transfers to intermediate local storages is optionally higher than direct transfers. Completing these transfers early will enable the completion of other data transfers from an intermediary in response to DREQ messages. While sending the first BLOCK of data for some DREQ, the sender updates its transmit schedule and then re-computes the priorities of all pending DREQ'S. Similarly, a receiver can update its receive schedule and re-compute the priorities of all scheduled transfers not in progress.

In one embodiment of the present invention, transfer module 300 accounts for transmission rate variations when reserving resources. Slack module 350 (FIG. 8B) reserves resources at a node in a data transfer path. Slack module 350 reserves resource based on the total available resources on each node involved in a data transfer and historical information about resource demand as a function of time. The amount of excess resources reserved is optionally based on statistical models of the historical information.

In one embodiment slack module 350 reserves a fixed percentage of all bandwidth resources (e.g. 20%). In an alternative embodiment, slack module 350 reserves a larger fraction of bandwidth resources at times when transfers have historically run behind schedule (e.g., between 2 and 5 PM on weekdays). The reserved fraction of bandwidth is optionally spread uniformly throughout each hour, or alternatively concentrated in small time intervals (e.g., 1 minute out of each 5 minute time period).

In one implementation, transfer module 300 further guards against transmission rate variations by padding bandwidth reserved for data transfers. Padding module 360 (FIG. 8B) in transfer module 300 determines an amount of padding time P. Transfer module 300 adds padding time P to an estimated data transfer time before scheduling module 320 qualifies a requested data transfer as acceptable. Padding time P is chosen such that the probability of completing the transfer before a deadline is above a specified value. In one embodiment, padding module 360 determines padding time based on the identities of the sender and receiver, a size of the data to be transferred, a maximum bandwidth expected for the transfer, and historical information about achieved transfer rates.

In one embodiment of padding module 360, P is set as follows:
P=MAX[MIN_{—}PAD, PAD_FRACTION*ST]
Wherein:
MAX [ ] is a function yielding the maximum value within the brackets;
ST is the scheduled transfer time; and
MIN_PAD and PAD_FRACTION are constants.

In one implementation MIN_PAD is 15 minutes, and PAD_FRACTION is 0.25. In alternative embodiments, MIN_PAD and PAD_FRACTION are varied as functions of time of day, sender-receiver pairs, or historical data. For example, when a scheduled transfer spans a 2 PM-5 PM interval, MIN_PAD may be increased by 30 minutes.

In another embodiment, P is set as follows:
P=ABS_{—}PAD+FRAC_{—}PAD_TIME
Wherein:
ABS_PAD is a fixed time (e.g., 5 seconds);
FRAC_PAD_TIME is the time required to transfer B bytes;
B=PAD_FRACTION*SIZE; and
SIZE is the size of the requested data file.

In this embodiment, available bandwidth is taken into account when FRAC_PAD_TIME is computed from B.

In further embodiments, transfer module 300 employs error recovery module 380 (FIG. 8B) to manage recovery from transfer errors. If a network failure occurs, connections drop, data transfers halt, and/or schedule negotiations timeout. Error recovery module 380 maintains a persistent state at each node, and the node uses that state to restart after a failure. Error recovery module 380 also minimizes (1) the amount of extra data transferred in completing interrupted transfers and (2) the number of accepted requests that are canceled as a result of failures and timeouts.

In one implementation, data is stored in each node to facilitate restarting data transfers. Examples of this data include data regarding requests accepted by scheduling module 320, resource allocation, the state of each transfer in progress, waiting lists 508 (if these are supported), and any state required to describe routing policies (e.g., proxy lists).

Error recovery module 380 maintains a persistent state in an incremental manner. For example, data stored by error recovery module 380 is updated each time one of the following events occurs: (1) a new request is accepted; (2) an old request is preempted or; (3) a DREQ transfers data of size BLOCK. The persistent state data is reduced at regular intervals by eliminating all requests and DREQs for transfers that have already been completed or have deadlines in the past.

In one embodiment, the persistent state for each sender includes the following: (1) a description of the allocated transmit bandwidth for each accepted request and (2) a summary of each transmission completed in response to a DREQ. The persistent state for each receiver includes the following: (1) a description of the allocated receive bandwidth and allocated space for each accepted request and (2) a summary of each data transfer completed in response to a DREQ.

Although many of the embodiments discussed above describe a distributed system, a centrally controlled system is within the scope of the invention. In one embodiment, a central control node, such as a server, includes transfer module 300. In the central control node, transfer module 300 evaluates each request for data transfers between nodes in communication network 10. Transfer module 300 in the central control node also manages the execution of scheduled data transfers and dynamic requests.

Transfer module 300 in the central control node periodically interrogates (polls) each node to ascertain the node's resources, such as bandwidth and storage space. Transfer module 300 then uses this information to determine whether a data transfer request should be accepted or denied. In this embodiment, transfer module 300 in the central control node includes software required to schedule and execute data transfers. This allows the amount of software needed at the other nodes in communications network 10 to be smaller than in fully distributed embodiments. In another embodiment, multiple central control devices are implemented in communications network 10.

FIG. 36 illustrates a high level block diagram of a computer system that can be used for the components of the present invention. The computer system in FIG. 36 includes processor unit 950 and main memory 952. Processor unit 950 may contain a single microprocessor, or may contain a plurality of microprocessors for configuring the computer system as a multi-processor system. Main memory 952 stores, in part, instructions and data for execution by processor unit 950. If the system of the present invention is wholly or partially implemented in software, main memory 952 can store the executable code when in operation. Main memory 952 may include banks of dynamic random access memory (DRAM) as well as high speed cache memory.

The system of FIG. 36 further includes mass storage device 954, peripheral device(s) 956, user input device(s) 960, portable storage medium drive(s) 962, graphics subsystem 964, and output display 966. For purposes of simplicity, the components shown in FIG. 36 are depicted as being connected via a single bus 968. However, the components may be connected through one or more data transport means. For example, processor unit 950 and main memory 952 may be connected via a local microprocessor bus, and the mass storage device 954, peripheral device(s) 956, portable storage medium drive(s) 962, and graphics subsystem 964 may be connected via one or more input/output (I/O) buses. Mass storage device 954, which may be implemented with a magnetic disk drive or an optical disk drive, is a non-volatile storage device for storing data and instructions for use by processor unit 950. In one embodiment, mass storage device 954 stores the system software for implementing the present invention for purposes of loading to main memory 952.

Portable storage medium drive 962 operates in conjunction with a portable non-volatile storage medium, such as a floppy disk, to input and output data and code to and from the computer system of FIG. 36. In one embodiment, the system software for implementing the present invention is stored on such a portable medium, and is input to the computer system via the portable storage medium drive 962. Peripheral device(s) 956 may include any type of computer support device, such as an input/output (I/O) interface, to add additional functionality to the computer system. For example, peripheral device(s) 956 may include a network interface for connecting the computer system to a network, a modem, a router, etc.

User input device(s) 960 provide a portion of a user interface. User input device(s) 960 may include an alpha-numeric keypad for inputting alpha-numeric and other information, or a pointing device, such as a mouse, a trackball, stylus, or cursor direction keys. In order to display textual and graphical information, the computer system of FIG. 36 includes graphics subsystem 964 and output display 966. Output display 966 may include a cathode ray tube (CRT) display, liquid crystal display (LCD) or other suitable display device. Graphics subsystem 964 receives textual and graphical information, and processes the information for output to display 966. Additionally, the system of FIG. 36 includes output devices 958. Examples of suitable output devices include speakers, printers, network interfaces, monitors, etc.

The components contained in the computer system of FIG. 36 are those typically found in computer systems suitable for use with the present invention, and are intended to represent a broad category of such computer components that are well known in the art. Thus, the computer system of FIG. 36 can be a personal computer, handheld computing device, Internet-enabled telephone, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method for managing a message transfer over a network, said method comprising the steps of:
(a) receiving an electronic message; and
(b) determining whether to arrange for background delivery of content associated with said electronic message.

2. A method according to claim 1, wherein said step (b) includes the step of:
(1) determining whether said electronic message satisfies a predetermined characteristic.

3. A method according to claim 2, wherein said predetermined characteristic is a size limit for said content.

4. A method according to claim 3, wherein it is determined in said step (b) to arrange for said background delivery if said content exceeds said size limit.

5. A method according to claim 1, wherein said method further includes the step of:
(c) preparing said content for background delivery in response to said determination made in said step (b).

6. A method according to claim 5, wherein said steps (a), (b), and (c) are performed by a proxy server.

7. A method according to claim 5, wherein said step (b) is performed by an e-mail client and said step (c) is performed by a proxy server.

8. A method according to claim 5, wherein said step (b) is performed by an e-mail client proxy and said step (c) is performed by a proxy server.

9. A method according to claim 5, wherein said electronic message is an e-mail and said content includes at least one attachment from said e-mail.

10. A method according to claim 5, wherein said content is a movie file.

11. A method according to claim 5, wherein said step (c) includes the steps of:
(1) creating an asset package for said content; and
(2) creating a launch asset.

12. A method according to claim 11, wherein said step (c)(1) includes the steps of:
(i) decoding said content to obtain decoded content; and
(ii) separating said decoded content into separate assets in said asset package.

13. A method according to claim 11, wherein said asset package contains said content.

14. A method according to claim 13, wherein said content contains at least one attachment and each attachment in said content is represented by an asset in said asset package.

15. A method according to claim 5, wherein said method includes the step of:
(d) sending a notice indicating availability of said content.

16. A method according to claim 15, wherein said notice identifies said content.

17. A method according to claim 16, wherein said notice includes program code for installing an attachment transfer client.

18. A method according to claim 16, wherein said notice includes a launch asset identifying said content.

19. A method according to claim 18, wherein said notice includes a notification message.

20. A method according to claim 5, wherein said method includes the step of:
(e) receiving a scheduling request associated with said content.

21. A method according to claim 20, wherein said method includes the steps of:
(f) requesting an identity of a node for use in retrieving said content;
(g) receiving said identity; and
(h) issuing said scheduling request to said node.

22. A method according to claim 21, wherein said node is a forward proxy.

23. A method according to claim 22, wherein said step (f) is performed in response to a notice indicating availability of said content.

24. A method according to claim 20, wherein said method includes the step of:
(j) servicing said scheduling request received in said step (e).

25. A method according to claim 24, wherein a first node receives said scheduling request and said step (j) includes the step of:
(1) said first node forwarding said content.

26. A method according to claim 25, wherein said step (j)(1) satisfies a bandwidth schedule associated with said scheduling request.

27. A method according to claim 26, wherein said content is forwarded in said step (j)(1) at a latest possible time that satisfies said bandwidth schedule.

28. A method according to claim 26, wherein said first node is a forward proxy.

29. A method according to claim 25, wherein said step (j) further includes the step of:
(2) said first node obtaining said content from a second node.

30. A method according to claim 24, wherein said step (j) includes the step of:
(3) determining a schedule for transmitting said content in response to said scheduling request.

31. A method according to claim 30, wherein said schedule is a latest possible schedule for delivering said content and satisfying said scheduling request.

32. A method according to claim 24, wherein said step (j) includes the step of:
(4) a first node transferring said content, wherein said first node received said scheduling request.

33. A method according to claim 32, wherein said step (j) includes the step of:
(5) said first node issuing a second scheduling request to a second node for said content.

34. A method according to claim 33, wherein said step (j) includes the step of:
(6) said first node receiving said content from said second node in response to said second scheduling request.

35. A method according to claim 34, wherein said steps (j)(5) and (j)(6) are performed if said first node does not have a local copy of said content.

36. A method according to claim 34, wherein said first node is a forward proxy and said second node is a content proxy.

37. A method according to claim 24, wherein said step (j) includes the step of:
(7) preempting service of a lower priority scheduling request to service said scheduling request.

38. A method according to claim 20, further including the step of:
(k) providing a soft rejection if said scheduling request cannot be satisfied.

39. A method according to claim 5, wherein said method further includes the step of:
(1) supplying status associated with delivery of said content.

40. A method according to claim 1, wherein said method further includes the steps of:
(m) arranging for background delivery of said content, if it is determined in said step (b) to arrange for background delivery of said content; and
(n) forwarding said electronic message without arranging for background delivery of said content, if it is determined in said step (b) not to arrange for background delivery of said content.

41. One or more processor readable storage devices having processor readable code embodied on said processor readable storage devices, said processor readable code for programming one or more processors to perform a method comprising the steps of:
(a) receiving an electronic message; and
(b) determining whether to arrange for background delivery of content associated with said electronic message.

42. One or more processor readable storage devices according to claim 41, wherein it is determined in said step (b) to arrange for said background delivery if said content exceeds a size limit.

43. One or more processor readable storage devices according to claim 41, wherein said method further includes the step of:
(c) preparing said content for background delivery in response to said determination made in said step (b).

44. One or more processor readable storage devices according to claim 43, wherein said electronic message is an e-mail and said content includes at least one attachment from said e-mail.

45. One or more processor readable storage devices according to claim 43, wherein said step (c) includes the steps of:
(1) creating an asset package for said content, wherein said asset package contains said content; and
(2) creating a launch asset.

46. One or more processor readable storage devices according to claim 45, wherein said step (c)(1) includes the steps of:
(i) decoding said content to obtain decoded content; and
(ii) separating said decoded content into separate assets in said asset package.

47. One or more processor readable storage devices according to claim 43, wherein said method includes the step of:
(d) sending a notice indicating availability of said content.

48. One or more processor readable storage devices according to claim 43, wherein said method includes the step of:
(e) servicing a scheduling request associated with said content.

49. One or more processor readable storage devices according to claim 48, wherein said step (e) includes the step of:
(1) forwarding said content.

50. One or more processor readable storage devices according to claim 49, wherein said step (e)(1) satisfies a bandwidth schedule associated with said scheduling request.

51. One or more processor readable storage devices according to claim 50, wherein said content is forwarded in said step (e)(1) at a latest possible time that satisfies said bandwidth schedule.

52. One or more processor readable storage devices according to claim 48, wherein said step (e) includes the step of:
(2) preempting service of a lower priority scheduling request to service said scheduling request.

53. One or more processor readable storage devices according to claim 48, wherein said method further includes the step of:
(f) providing a soft rejection if said scheduling request cannot be satisfied.

54. One or more processor readable storage devices according to claim 41, wherein said method further includes the steps of:
(g) arranging for background delivery of said content, if it is determined in said step (b) to arrange for background delivery of said content; and
(h) forwarding said electronic message without arranging for background delivery of said content, if it is determined in said step (b) not to arrange for background delivery of said content.

55. An apparatus comprising:
one or more communications interfaces;
one or more storage devices; and
one or more processors in communication with said one or more storage devices and said one or more communication interfaces, said one or more processors perform a method for managing a message transfer over a network, said method comprising the steps of:
(a) receiving an electronic message; and
(b) determining whether to arrange for background delivery of content associated with said electronic message.

56. An apparatus according to claim 55, wherein it is determined in said step (b) to arrange for said background delivery if said content exceeds a size limit.

57. An apparatus according to claim 55, wherein said method further includes the step of:
(c) preparing said content for background delivery in response to said determination made in said step (b).

58. An apparatus according to claim 57, wherein said step (c) includes the steps of:
(1) creating an asset package for said content, wherein said asset package contains said content; and
(2) creating a launch asset.

59. An apparatus according to claim 57, wherein said method includes the step of:
(d) sending a notice indicating availability of said content.

60. An apparatus according to claim 57, wherein said method includes the step of:
(e) servicing a scheduling request associated with said content.

61. An apparatus according to claim 60, wherein said step (e) includes the step of:
(1) forwarding said content, wherein said step (e)(1) satisfies a bandwidth schedule associated with said scheduling request.

62. An apparatus according to claim 61, wherein said content is forwarded in said step (c)(1) at a latest possible time that satisfies said bandwidth schedule.

63. An apparatus according to claim 55, wherein said method further includes the steps of:
(f) arranging for background delivery of said content, if it is determined in said step (b) to arrange for background delivery of said content; and
(g) forwarding said electronic message without arranging for background delivery of said content, if it is determined in said step (b) not to arrange for background delivery of said content.

64. A method for managing a message transfer over a network, said method comprising the steps of:
(a) receiving an electronic message; and
(b) preparing content associated with said electronic message for background delivery.

65. A method according to claim 64, wherein said electronic message is an e-mail and said content includes at least one attachment from said e-mail.

66. A method according to claim 64, wherein said step (b) includes the steps of:
(1) creating an asset package for said content, wherein said asset package contains said content; and
(2) creating a launch asset.

67. A method according to claim 64, wherein said method includes the step of:
(c) sending a notice indicating availability of said content.

68. A method according to claim 67, wherein said notice includes a launch asset identifying said content.

69. A method according to claim 67, wherein said method includes the step of:
(d) receiving a scheduling request associated with said content.

70. A method according to claim 69, wherein said method includes the steps of:
(e) requesting an identity of a forward proxy for use in retrieving said content;
(f) receiving said identity; and
(g) issuing said scheduling request to said forward proxy.

71. A method according to claim 69, wherein said method includes the step of:
(h) servicing said scheduling request received in said step (d).

72. A method according to claim 71, wherein said step (h) includes the step of:
(1) a forward proxy transferring said content to satisfy said scheduling request, wherein said forward proxy received said scheduling request.

73. A method according to claim 72, wherein said step (h) includes the step of:
(2) said forward proxy determining a first bandwidth schedule for transferring said content to satisfy a second bandwidth schedule associated with said scheduling request.

74. A method according to claim 73, wherein said first bandwidth schedule is a latest possible bandwidth schedule for satisfying said second bandwidth schedule.

75. A method according to claim 72, wherein said step (h) includes the steps of:
(3) said forward proxy issuing a second scheduling request to a content proxy for said content;
(4) said forward proxy receiving said content from said content proxy to satisfy said second scheduling request.

76. One or more processor readable storage devices having processor readable code embodied on said processor readable storage devices, said processor readable code for programming one or more processors to perform a method comprising the steps of:
(a) receiving an electronic message; and
(b) preparing content associated with said electronic message for background delivery.

77. One or more processor readable storage devices according to claim 76, wherein said electronic message is an e-mail and said content includes at least one attachment from said e-mail.

78. One or more processor readable storage devices according to claim 76, wherein said step (b) includes the steps of:
(1) creating an asset package for said content, wherein said asset package contains said content; and
(2) creating a launch asset.

79. One or more processor readable storage devices according to claim 76, wherein said method includes the step of:
(c) sending a notice indicating availability of said content.

80. One or more processor readable storage devices according to claim 76, wherein said method includes the step of:
(d) servicing a scheduling request associated with said content.

81. One or more processor readable storage devices according to claim 80, wherein said step (d) includes the step of:
(1) transferring said content to satisfy said scheduling request.

82. One or more processor readable storage devices according to claim 81, wherein said step (d) includes the step of:
(2) determining a first bandwidth schedule for transferring said content to satisfy a second bandwidth schedule associated with said scheduling request.

83. One or more processor readable storage devices according to claim 82, wherein said first bandwidth schedule is a latest possible bandwidth schedule for satisfying said second bandwidth schedule.

84. An apparatus comprising:
one or more communications interfaces;
one or more storage devices; and
one or more processors in communication with said one or more storage devices and said one or more communication interfaces, said one or more processors perform a method for managing a message transfer over a network, said method comprising the steps of:
(a) receiving an electronic message; and
(b) preparing content associated with said electronic message for background delivery.

85. An apparatus according to claim 84, wherein said step (b) includes the steps of:
(1) creating an asset package for said content, wherein said asset package contains said content; and
(2) creating a launch asset.

86. An apparatus according to claim 84, wherein said method includes the step of:
(d) servicing a scheduling request associated with said content.

87. An apparatus according to claim 86, wherein said step (d) includes the step of:
(1) transferring said content to satisfy said scheduling request.

88. An apparatus according to claim 87, wherein said step (d) includes the step of:
(2) determining a first bandwidth schedule for transferring said content to satisfy a second bandwidth schedule associated with said scheduling request.
